(19) United States
(12) Patent Application Publication
(10) Pub. No.: US 2024/0381144 A1
(43) Pub. Date: Nov. 14, 2024

(54) CHANNEL SOUNDING METHOD AND APPARATUS

(71) Applicant: HUAWEI TECHNOLOGIES CO., LTD., Shenzhen (CN)

(72) Inventors: Jian YU, Shenzhen (CN); Shimon SHILO, Hod Hasharon (IL); Oded REDLICH, Hod Hasharon (IL); Arik KLEIN, Hod Hasharon (IL); Ming GAN, Shenzhen (CN)

(21) Appl. No.: 18/783,675

(22) Filed: Jul. 25, 2024

Related U.S. Application Data
(63) Continuation of application No. PCT/CN2023/071063, filed on Jan. 6, 2023.

(30) Foreign Application Priority Data
Jan. 26, 2022 (CN) 202210094908.8

(51) Int. Cl. H04W 24/08; H04L 1/00

(52) U.S. Cl. CPC H04W 24/08; H04L 1/0013

(57) ABSTRACT

A channel sounding method and a channel sounding apparatus are disclosed. The method includes: A first communication apparatus sends a null data packet announcement (NDPA) frame, and sends a null data packet (NDP); and a second communication apparatus and a third communication apparatus receive the NDPA frame and the NDP. The NDPA frame includes first indication information, where the first indication information indicates that the NDPA frame is for orthogonal frequency division multiplexing multiple access (OFDMA) and non-OFDMA hybrid channel sounding, a total bandwidth of the NDP is a first bandwidth, a portion of the NDP in the first bandwidth is used by the second communication apparatus to obtain channel state information between the second and the first communication apparatus, a portion of the NDP in a second bandwidth is used by the third communication apparatus to obtain channel state information between the third communication apparatus and the first communication apparatus, the second bandwidth is a part of the first bandwidth, and the first bandwidth is greater than 80 MHz.

### CROSS-REFERENCE TO RELATED APPLICATIONS

This application is a continuation of International Application No. PCT/CN2023/071063, filed on Jan. 6, 2023, which claims priority to Chinese Patent Application No. 202210094908.8, filed on Jan. 26, 2022. The disclosures of the aforementioned applications are hereby incorporated by reference in their entireties.

### TECHNICAL FIELD

The present disclosure relates to the field of communication technologies, and in particular, to a channel sounding method and an apparatus.

### BACKGROUND

In a wireless system like a wireless local area network (WLAN), an access point (AP) and a station (STA) usually need to obtain channel state information through channel sounding, and perform beamforming (BF), resource scheduling, and the like based on the channel state information, to improve channel quality and throughput.

When an AP performs channel sounding with STAs, the AP needs to separately perform channel sounding with the different STAs in a time division multiplexing manner. For example, the AP needs to perform, in the time division multiplexing manner, orthogonal frequency division multiple access (OFDMA) based channel sounding with one STA, and perform non-OFDMA-based channel sounding with another STA.

However, efficiency of the foregoing channel sounding method still needs to be improved.

### SUMMARY

The present disclosure provides a channel sounding method and an apparatus, to effectively improve channel sounding efficiency.

According to a first aspect, an embodiment of the present disclosure provides a channel sounding method. The method includes: A first communication apparatus sends a null data packet announcement (NDPA) frame, where the NDPA frame includes first indication information, and the first indication information indicates that the NDPA frame is for orthogonal frequency division multiple access (OFDMA) and non-OFDMA hybrid channel sounding; and the first communication apparatus sends a null data packet (NDP), where a total bandwidth of the NDP is a first bandwidth, a corresponding NDP in the first bandwidth is used by a second communication apparatus to obtain channel state information between the second communication apparatus and the first communication apparatus, a corresponding NDP in a second bandwidth is used by a third communication apparatus to obtain channel state information between the third communication apparatus and the first communication apparatus, the second bandwidth is a part of the first bandwidth, and the first bandwidth is greater than 80 MHz.

In this embodiment, the first communication apparatus may simultaneously perform channel sounding with the second communication apparatus and the third communication apparatus, so that the first communication apparatus can obtain the channel state information between the first communication apparatus and the second communication apparatus and the channel state information between the first communication apparatus and the third communication apparatus in one channel sounding procedure. This not only improves channel utilization, but also improves channel sounding efficiency.

In a possible implementation, the method further includes at least one of the following: The first communication apparatus receives a first beamforming report from the second communication apparatus, where the first beamforming report indicates the channel state information in the first bandwidth; and the first communication apparatus receives a second beamforming report from the third communication apparatus, where the second beamforming report indicates the channel state information in the second bandwidth.

According to a second aspect, an embodiment of the present disclosure provides a channel sounding method. The method includes: A second communication apparatus receives a null data packet announcement NDPA frame, where the NDPA frame includes first indication information, and the first indication information indicates that the NDPA frame is for orthogonal frequency division multiplexing multiple access OFDMA and non-OFDMA hybrid channel sounding; and the second communication apparatus receives a null data packet NDP, where a total bandwidth of the NDP is a first bandwidth, and a corresponding NDP in the first bandwidth is used by the second communication apparatus to obtain channel state information between the second communication apparatus and a first communication apparatus.

In a possible implementation, the second communication apparatus sends a first beamforming report to the first communication apparatus, where the first beamforming report indicates the channel state information in the first bandwidth.

With reference to the first aspect or the second aspect, in a possible implementation, the NDPA frame further includes second indication information, where the second indication information indicates puncturing information in the first bandwidth.

With reference to the first aspect or the second aspect, in a possible implementation, the second indication information further indicates the second communication apparatus to feed back channel state information of a nonpunctured subchannel in the first bandwidth.

With reference to the first aspect or the second aspect, in a possible implementation, the NDP includes third indication information, where the third indication information indicates puncturing information in the first bandwidth.

With reference to the first aspect or the second aspect, in a possible implementation, the third indication information is carried in a first universal signal (universal SIG, U-SIG) field, and that the third indication information indicates puncturing information in the first bandwidth includes: The third indication information indicates puncturing information in one or more frequency subblocks in the first bandwidth.

With reference to the first aspect or the second aspect, in a possible implementation, the third indication information is carried in a first extremely high throughput signal (EHT-SIG) field.

With reference to the first aspect or the second aspect, in a possible implementation, the NDP further includes first format information, where the first format information indicates that an NDP in the first bandwidth is an OFDMA-based NDP.

With reference to the first aspect or the second aspect, in a possible implementation, the NDP includes a second universal signal U-SIG field, the second U-SIG field includes fourth indication information and second format information, the fourth indication information indicates puncturing information in the second bandwidth, and the second format information indicates that the NDP in the second bandwidth is a non-OFDMA-based NDP.

With reference to the first aspect or the second aspect, in a possible implementation, the NDPA frame further includes bandwidth information, where the bandwidth information indicates at least one of the first bandwidth or the second bandwidth.

It may be understood that, that a piece of information is carried in a field in this embodiment may also be understood as that the piece of information is included in the field. Similar descriptions are not limited in this embodiment.

According to a third aspect, an embodiment of the present disclosure provides a first communication apparatus that is configured to perform the method in any one of the first aspect or the possible implementations of the first aspect. The first communication apparatus includes a unit that performs the method in any one of the first aspect or the possible implementations of the first aspect.

According to a fourth aspect, an embodiment of the present disclosure provides a second communication apparatus that is configured to perform the method in any one of the second aspect or the possible implementations of the second aspect. The second communication apparatus includes a unit that performs the method in any one of the second aspect or the possible implementations of the second aspect.

In the third aspect or the fourth aspect, the first communication apparatus and the second communication apparatus may include a transceiver unit and a processing unit. For specific descriptions of the transceiver unit and the processing unit, refer to apparatus embodiments provided below.

According to a fifth aspect, an embodiment of the present disclosure provides a first communication apparatus. The first communication apparatus includes a processor that is configured to perform the method in any one of the first aspect or the possible implementations of the first aspect. Alternatively, the processor is configured to execute a program stored in a memory, and when the program is executed, the method in any one of the first aspect or the possible implementations of the first aspect is performed.

In a possible implementation, the memory is located outside the first communication apparatus.

In a possible implementation, the memory is located in the first communication apparatus.

In this embodiment, the processor and the memory may alternatively be integrated into one device. In other words, the processor and the memory may alternatively be integrated together.

In a possible implementation, the first communication apparatus further includes a transceiver, and the transceiver is configured to receive a signal or send a signal.

According to a sixth aspect, an embodiment of the present disclosure provides a second communication apparatus. The second communication apparatus includes a processor that is configured to perform the method in any one of the second aspect or the possible implementations of the second aspect. Alternatively, the processor is configured to execute a program stored in a memory, and when the program is executed, the method in any one of the second aspect or the possible implementations of the second aspect is performed.

In a possible implementation, the memory is located outside the second communication apparatus.

In a possible implementation, the memory is located in the second communication apparatus.

In this embodiment, the processor and the memory may alternatively be integrated into one device. In other words, the processor and the memory may alternatively be integrated together.

In a possible implementation, the second communication apparatus further includes a transceiver, and the transceiver is configured to receive a signal or send a signal.

According to a seventh aspect, an embodiment of the present disclosure provides a first communication apparatus. The communication apparatus includes a logic circuit and an interface, where the logic circuit is coupled to the interface, the logic circuit is configured to obtain an NDPA frame, the interface is configured to output the NDPA frame, the logic circuit is configured to obtain an NDP, and the interface is configured to output the NDP.

In a possible implementation, the interface is further configured to input a first beamforming report and a second beamforming report.

According to an eighth aspect, an embodiment of the present disclosure provides a second communication apparatus. The communication apparatus includes a logic circuit and an interface, where the logic circuit is coupled to the interface, and the interface is configured to input an NDPA frame and an NDP.

For example, the logic circuit is configured to perform channel estimation based on the NDPA frame and the NDP, to obtain a first beamforming report.

In a possible implementation, the interface is further configured to output the first beamforming report.

According to a ninth aspect, an embodiment of the present disclosure provides a computer-readable storage medium. The computer-readable storage medium is configured to store a computer program, and when the computer program is run on a computer, the method according to any one of the first aspect or the possible implementations of the first aspect is performed.

According to a tenth aspect, an embodiment of the present disclosure provides a computer-readable storage medium. The computer-readable storage medium is configured to store a computer program, and when the computer program is run on a computer, the method according to any one of the second aspect or the possible implementations of the second aspect is performed.

According to an eleventh aspect, an embodiment of the present disclosure provides a computer program product. The computer program product includes a computer program or computer code, and when the computer program product runs on a computer, the method in any one of the first aspect or the possible implementations of the first aspect is performed.

According to a twelfth aspect, an embodiment of the present disclosure provides a computer program product. The computer program product includes a computer program or computer code, and when the computer program product runs on a computer, the method in any one of the second aspect or the possible implementations of the second aspect is performed.

According to a thirteenth aspect, an embodiment of the present disclosure provides a computer program. When the computer program is run on a computer, the method in any one of the first aspect or the possible implementations of the first aspect is performed.

According to a fourteenth aspect, an embodiment of the present disclosure provides a computer program. When the computer program is run on a computer, the method in any one of the second aspect or the possible implementations of the second aspect is performed.

According to a fifteenth aspect, an embodiment of the present disclosure provides a wireless communication system. The wireless communication system includes a first communication apparatus and a second communication apparatus, where the first communication apparatus is configured to perform the method in any one of the first aspect or the possible implementations of the first aspect, and the second communication apparatus is configured to perform the method in any one of the second aspect or the possible implementations of the second aspect.

### BRIEF DESCRIPTION OF DRAWINGS

FIG. 1 is a diagram of structures of both an example access point and an example station according to an embodiment of the present disclosure;

FIG. 2 is a diagram of an architecture of an example communication system according to an embodiment of the present disclosure;

FIG. 3 is a schematic flowchart of an example channel sounding method according to an embodiment of the present disclosure;

FIG. 4a and FIG. 4b are diagrams of a structure of an example NDPA frame according to an embodiment of the present disclosure;

FIG. 5a to FIG. 5c are diagrams of a structure of an example NDP according to an embodiment of the present disclosure;

FIG. 6 is a diagram of an example trigger-based (TB) EHT channel sounding method according to an embodiment of the present disclosure; and

FIG. 7 to FIG. 9 are diagrams of a structure of an example communication apparatus according to an embodiment of the present disclosure.

### DESCRIPTION OF EMBODIMENTS

To make the objectives, technical solutions, and advantages of the present disclosure clearer, the present disclosure is further described with reference to accompanying drawings.

Terms “first”, “second”, and the like in the specification, claims, and accompanying drawings of the present disclosure are merely used to distinguish between different objects, and are not used to describe a specific order. In addition, terms such as “include” and “have” and any other variants thereof are intended to cover a non-exclusive inclusion. For example, processes, methods, systems, products, or devices that include a series of steps or units are not limited to listed steps or units, but instead, optionally further include steps or units that are not listed, or optionally further include other steps or units inherent to these processes, methods, products, or devices.

An “embodiment” mentioned in this specification means that a specific feature, structure, or characteristic described in combination with the embodiment may be included in at least one embodiment of the present disclosure. The phrase shown in various locations in the specification may not necessarily refer to a same embodiment, and is not an independent or optional embodiment exclusive from another embodiment. It may be understood explicitly and implicitly by a person skilled in the art that embodiments described herein may be combined with other embodiments.

In the present disclosure, “at least one (item)” means one or more, “a plurality of” means two or more, “at least two (items)” means two or three or more, and “and/or” is used to describe an association relationship between associated objects and indicates that three relationships may exist. For example, “A and/or B” may indicate: Only A exists, only B exists, or both A and B exist, where A and B may be singular or plural. The character “/” usually indicates an “or” relationship between the associated objects. “At least one of the following” or a similar expression thereof means any combination of these items. For example, at least one of a, b, or c may represent: a, b, c, “a and b”, “a and c”, “b and c”, or “a and b and c”.

The method provided in the present disclosure may be applied to a wireless local area network (WLAN) system, for example, Wi-Fi. For example, the method provided in the present disclosure is applicable to the institute of electrical and electronics engineers (IEEE) 802.11 series protocols, for example, the 802.11a/b/g protocol, the 802.11n protocol, the 802.11ac protocol, the 802.11ax protocol, the 802.11be protocol, or a next-generation protocol. Examples not enumerated herein. The method provided in the present disclosure is further applied to various communication systems, for example, an internet of things (IoT) system, a narrowband internet of things (NB-IoT) system, a long term evolution (LTE) system, a 5th generation (5G) communication system, and a new communication system (for example, 6G) emerging in future communication development.

The method provided in the present disclosure may be implemented by a communication apparatus in a wireless communication system. For example, the communication apparatus may be at least one of an access point (AP) or a station (STA).

The access point is an apparatus having a wireless communication function, supports communication or sensing by using a WLAN protocol, has a function of communicating or sensing with another device (for example, a station or another access point) in a WLAN network, and certainly, may further have a function of communicating or sensing with another device. Alternatively, the access point is equivalent to a bridge that connects a wired network and a wireless network, and a main function of the access point is to connect various wireless network clients together and then connect the wireless network to the Ethernet. In a WLAN system, the access point may be referred to as an access point station (AP STA). The apparatus having the wireless communication function may be an entire device, or may be a chip or a processing system installed in the entire device. The device in which the chip or the processing system is installed may implement the method and a function in embodiments of the present disclosure under control of the chip or the processing system. The AP in embodiments of the present disclosure is an apparatus that provides a service for the STA, and may support 802.11 series protocols. For example, the access point may be an access point for a terminal (for example, a mobile phone) to access a wired (or wireless) network, and is mainly deployed in a home, a building, and a campus. A typical coverage radius of the access point is tens of meters to hundreds of meters, and certainly, the access point may alternatively be deployed outdoors. For another example, the AP may be a communication entity such as a communication server, a router, a switch, or a bridge; the AP may include various forms of macro base stations, micro base stations, relay stations, and the like; and certainly, the AP may alternatively be a chip or a processing system in these devices in various forms, to implement the method and the function in embodiments of the present disclosure. The access point in the present disclosure may be a high efficient (HE) AP or an extremely high throughput (EHT) AP, or may be an access point applicable to a future Wi-Fi standard, or the like.

The station is an apparatus having a wireless communication function, supports communication or sensing by using a WLAN protocol, and has a capability of communicating with or sensing another station or an access point in the WLAN network. In the WLAN system, the station may be referred to as a non-access point station (non-AP STA). For example, the STA is any user communication device that allows a user to communicate with or sense an AP and further communicate with the WLAN. The apparatus having the wireless communication function may be an entire device, or may be a chip or processing system installed in the entire device. The device in which the chip or the processing system is installed may implement the method and the function in embodiments of the present disclosure under control of the chip or the processing system. For example, the station may be a wireless communication chip, a wireless sensor, or a wireless communication terminal, and may also be referred to as a user. For example, the station may be a mobile phone supporting a Wi-Fi communication function, a tablet computer supporting a Wi-Fi communication function, a set-top box supporting a Wi-Fi communication function, a smart television supporting a Wi-Fi communication function, a smart wearable device supporting a Wi-Fi communication function, a vehicle-mounted communication device supporting a Wi-Fi communication function, a computer supporting a Wi-Fi communication function, or the like.

The WLAN system can provide high-speed and low-latency transmission. With continuous evolution of WLAN application scenarios, the WLAN system is to be applicable to more scenarios or industries, for example, an internet of things industry, an internet of vehicles industry, a banking industry, enterprise offices, exhibition halls of stadiums, concert halls, hotel rooms, dormitories, wards, classrooms, supermarkets, squares, streets, production workshops and warehousing. Certainly, a device (for example, an access point or a station) that supports WLAN communication or sensing may be a sensor node (for example, a smart water meter, a smart electricity meter, or a smart air detection node) in a smart city, a smart device (for example, a smart camera, a projector, a display, a television, a stereo, a refrigerator, or a washing machine) in smart home, a node in the internet of things, an entertainment terminal (for example, a wearable device such as AR and VR), a smart device (for example, a printer, a projector, a loudspeaker, or a stereo) in smart office, an internet of vehicles device in the internet of vehicles, an infrastructure (for example, a vending machine, a self-service navigation station of a supermarket, a self-service cash register device, or a self-service ordering machine) in daily life scenarios, a device in a large sports and music venue, or the like. For example, the access point and the station may be devices applied to the internet of vehicles, internet of things nodes in the internet of things (IoT), or sensors, or may be smart cameras, smart remote controls, or smart water/electricity meters in a smart home, or sensors in a smart city. Specific forms of the STA and the AP are not limited in embodiments of the present disclosure, and are merely examples for description herein.

Although the present disclosure is mainly described by using a network in which IEEE 802.11 is deployed as an example, a person skilled in the art easily understands that various aspects of the present disclosure may be expanded to other networks that use various standards or protocols, for example, Bluetooth, a high performance radio LAN (HIPERLAN) (which is a wireless standard similar to the IEEE 802.11 standard, and is mainly used in Europe) and a wide area network (WAN), a wireless local area network (WLAN), a personal area network (PAN), or another known or later developed network.

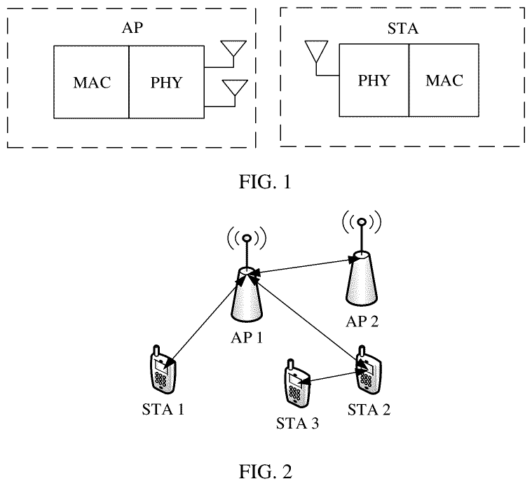

For example, FIG. 1 is a diagram of structures of both an access point and a station according to an embodiment of the present disclosure. The AP may be a multi-antenna AP or a single-antenna AP. As shown in FIG. 1, the AP includes a physical layer (PHY) processing circuit and a medium access control (MAC) processing circuit. The physical layer processing circuit may be configured to process a physical layer signal, and the MAC layer processing circuit may be configured to process a MAC layer signal. The 802.11 standard focuses on PHY and MAC parts. FIG. 1 further shows a diagram of a structure of a STA having a single antenna. In an actual scenario, the STA may alternatively have a plurality of antennas, and may be a device having more than two antennas. The STA may include a PHY processing circuit and a MAC processing circuit. The physical layer processing circuit may be configured to process a physical layer signal, and the MAC layer processing circuit may be configured to process a MAC layer signal. It may be understood that the structures of both the access point and the station shown in FIG. 1 are merely examples. For example, the access point and the station may further include at least one of a memory, a scheduler, a controller, a processor, or a radio frequency circuit. For specific descriptions of the station and the access point, refer to the following apparatus embodiments.

For example, a communication system to which the method provided in the present disclosure is applied may include an access point (AP) and a station (STA). The access point may also be understood as an access point entity, and the station may also be understood as a station entity. For example, the present disclosure is applicable to a scenario in which an AP communicates with or senses a STA in a WLAN. Optionally, the AP may communicate with or sense a single STA, or the AP may simultaneously communicate with or sense a plurality of STAs. Specifically, communication or sensing between the AP and the plurality of STAs may be classified into downlink transmission in which the AP simultaneously sends signals to the plurality of STAs and uplink transmission in which the plurality of STAs send signals to the AP. A WLAN communication protocol may be supported between the AP and the STA, and the communication protocol may include protocols of the IEEE 802.11 series, for example, may be applicable to the 802.11be standard, and certainly is also applicable to standards later than 802.11be.

FIG. 2 is a diagram of an architecture of a communication system according to an embodiment of the present disclosure. The communication system may include one or more APs and one or more STAs. FIG. 2 shows two access points, for example, an AP 1 and an AP 2, and three stations, for example, a STA 1, a STA 2, and a STA 3. It may be understood that the one or more APs may communicate with the one or more STAs. Certainly, APs may communicate with each other, and STAs may communicate with each other.

It may be understood that, in FIG. 2, an example in which the STA is a mobile phone and the AP is a router is used, and this does not mean that types of the AP and the STA in the present disclosure are limited. In addition, FIG. 2 shows only two APs and three STAs as an example. However, there may be more or fewer APs or STAs. This is not limited in the present disclosure.

In communication apparatuses shown below in the present disclosure, a first communication apparatus may be referred to as a beamformer (Bfer), and a second communication apparatus and a third communication apparatus may be referred to as beamformees (Bfee). The first communication apparatus may be an access point or a station, the second communication apparatus may be an access point or a station, and the third communication apparatus may be an access point or a station. For example, the first communication apparatus may be an access point, and both the second communication apparatus and the third communication apparatus may be stations. For another example, the first communication apparatus may be a station, and both the second communication apparatus and the third communication apparatus may be access points. For another example, the first communication apparatus is a station, and the second communication apparatus and the third communication apparatus are respectively a station and an access point. For another example, the first communication apparatus is an access point, and the second communication apparatus and the third communication apparatus are respectively a station and an access point. Examples are not enumerated herein.

Differences between the second communication apparatus and the third communication apparatus include at least one of the following:

1. The second communication apparatus may be understood as a beamformee that can support at least OFDMA-based channel sounding. In other words, an apparatus that can support OFDMA channel sounding is referred to as the second communication apparatus, or an apparatus that can support both OFDMA channel sounding and non-OFDMA channel sounding is referred to as the second communication apparatus. The third communication apparatus may be understood as a beamformee that can support non-OFDMA-based channel sounding. In other words, an apparatus that can support non-OFDMA channel sounding is referred to as the third communication apparatus.

2. The third communication apparatus may be understood as a device that implements an EHT basic feature, for example, may be represented by using an attribute value (for example, dot11EHTBaseLineFeaturesImplementedOnly) 1 in a management information base. The second communication apparatus may be understood as a device on which not only the EHT basic feature is implemented (a device that implements not only the EHT basic feature), or a device that implements an EHT advanced feature, for example, may be represented by using an attribute value 0 in the management information base.

3. The third communication apparatus may be understood as being capable of implementing methods, steps, functions, or the like in a release 1 (R1) in the 802.11be standard. The second communication apparatus may be understood as being capable of implementing methods, steps, or functions in subsequent standards in addition to the methods, the steps, the functions, or the like in the R1 in the 802.11be standard. For example, the second communication apparatus may be understood as being capable of implementing methods, steps, or functions in a release 2 (R2) in the 802.11be standard. For example, the third communication apparatus may be referred to as an R1 station, and the second communication apparatus may be referred to as an R2 station. For another example, the third communication apparatus may be referred to as a station supporting the R1, and the second communication apparatus may be referred to as a station supporting the R2.

4. Category indications in the second communication apparatus and the third communication apparatus are different. For example, the category indication may be included in a capability information element of a management frame. For example, the category indication may be included in a beacon frame or an association response frame, and categories of the second communication apparatus and the third communication apparatus are indicated by using the category indications.

The foregoing differences between the second communication apparatus and the third communication apparatus are merely examples. Methods or functions implemented by the second communication apparatus and the third communication apparatus may also be referred to as method embodiments shown below.

The present disclosure provides a channel sounding method and an apparatus. When the first communication apparatus initiates a channel sounding procedure, two different communication apparatuses (for example, the second communication apparatus and the third communication apparatus) can be supported to simultaneously feed back channel state information. This implements channel sounding processes of the two different communication apparatuses while fully utilizing a channel, and effectively improves channel sounding efficiency. Generally, when the first communication apparatus initiates the channel sounding procedure, the first communication apparatus can implement the channel sounding procedure with only one type of communication apparatus (for example, the second communication apparatus or the third communication apparatus). However, according to the method provided in embodiments of the present disclosure, the first communication apparatus may simultaneously perform channel sounding with the second communication apparatus and the third communication apparatus, so that the first communication apparatus can obtain channel state information between the first communication apparatus and the second communication apparatus and channel state information between the first communication apparatus and the third communication apparatus in one channel sounding procedure. This not only improves channel utilization, but also improves channel sounding efficiency.

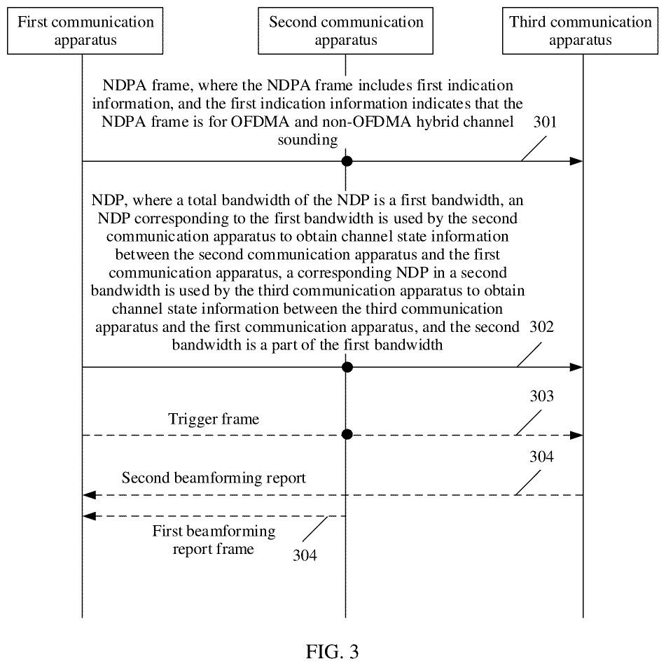

FIG. 3 is a schematic flowchart of a channel sounding method according to an embodiment of the present disclosure. The method is applied to the communication system shown in FIG. 2. For a first communication apparatus, a second communication apparatus, and a third communication apparatus in the method, refer to the foregoing descriptions. It should be noted that, in some examples shown below, the first communication apparatus is shown by using an AP as an example, and the second communication apparatus and the third communication apparatus are shown by using STAs as an example. For example, the second communication apparatus is referred to as an R2 station for short, and the third communication apparatus is referred to as an R1 station for short. However, this should not be understood as a limitation on embodiments of the present disclosure.

As shown in FIG. 3, the method includes the following steps.

301: The first communication apparatus sends an NDPA frame, where the NDPA frame includes first indication information, and the first indication information indicates that the NDPA frame is for OFDMA and non-OFDMA hybrid channel sounding.

Correspondingly, the second communication apparatus receives the NDPA frame, and the third communication apparatus receives the NDPA frame.

The NDPA frame shown in embodiments of the present disclosure may include an EHT NDPA frame, an NDPA frame in a future standard, or the like. A name of the NDPA frame is not limited in embodiments of the present disclosure.

That the first indication information indicates that the NDPA frame is for OFDMA and non-OFDMA hybrid channel sounding may also be understood as follows: The NDPA frame indicates that the second communication apparatus and the third communication apparatus are allowed to simultaneously participate in current channel sounding; the NDPA frame indicates that current channel sounding is hybrid channel sounding in which both the second communication apparatus and the third communication apparatus need to participate; the NDPA frame indicates that current channel sounding is OFDMA channel sounding (that is, the second communication apparatus may not care whether the third communication apparatus participates); both OFDMA channel sounding and non-OFDMA channel sounding are supported in channel sounding initiated based on the NDPA frame; or the first communication apparatus may simultaneously obtain, based on channel sounding initiated based on the NDPA frame, channel state information between the first communication apparatus and the second communication apparatus and channel state information between the first communication apparatus and the third communication apparatus. The second communication apparatus may learn of, based on the first indication information, that beamformees in a current channel sounding procedure include not only the second communication apparatus, but also the third communication apparatus. The first indication information may be implemented in the following two implementations.

### Implementation A:

The first indication information is included in a station information (STA information, STA info) field. For example, a station information field that includes an identifier of the second communication apparatus and that is in the NDPA frame may include the first indication information. For example, the first indication information may be included in a station information field that includes an association identifier 11 (AID11) subfield and that is in the NDPA frame, where the association identifier 11 subfield indicates the identifier of the second communication apparatus.

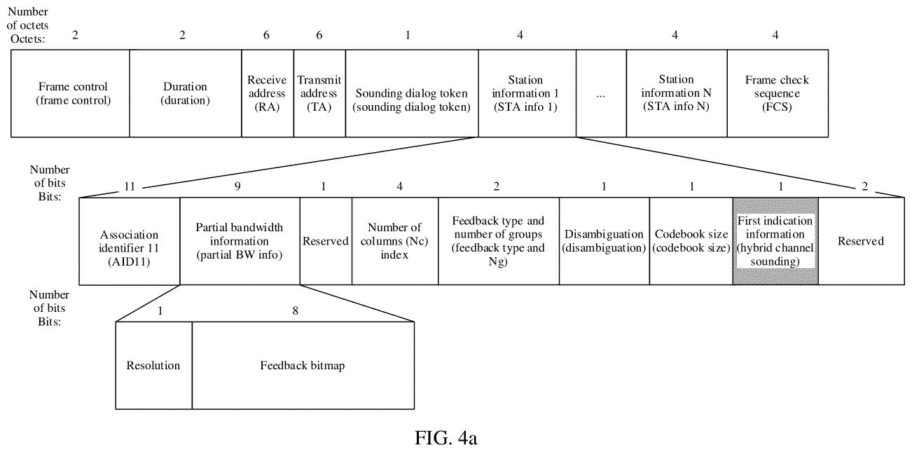

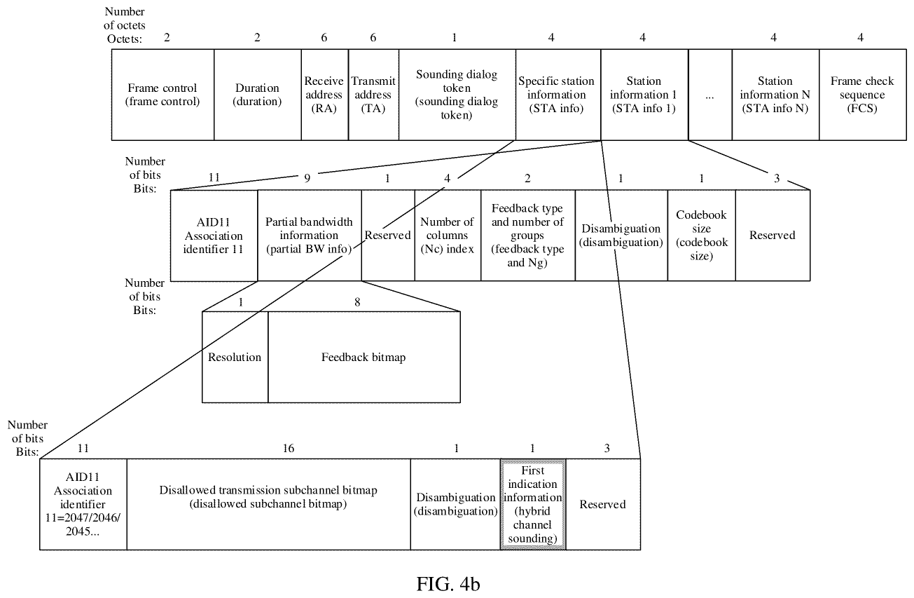

For example, content of the NDPA frame may be shown in FIG. 4a. The NDPA frame may include a station information 1 (STA info 1) field, . . . , and a station information N (STA info N) field. N is an integer greater than or equal to 2, and N is a sum of a number of second communication apparatuses and a number of third communication apparatuses. For example, 11 least significant bits of the association identifier AID11 in the station information 1 field indicate that the station information 1 field is sent to the second communication apparatus (which may also be understood as that a target station of the station information 1 field is the second communication apparatus), that is, indicate that the second communication apparatus may perform channel sounding based on the station information 1 field. Therefore, the second communication apparatus may learn of, by reading the first indication information, that current channel sounding is hybrid channel sounding. For example, the NDPA frame includes both a station information field sent to the second communication apparatus and a station information field sent to the third communication apparatus. For example, a value of the AID11 subfield may be any value from 1 to 2007, and the any value from 1 to 2007 indicates that the station information 1 field is sent to the second communication apparatus. Generally, after each station is associated with an AP, a unique AID is allocated to each station. Therefore, both an R1 station and an R2 station read an AID11 first. If the AID11 matches an AID of the R1 station and an AID of the R2 station, the R1 station and the R2 station read the station information field. Otherwise, the R1 station and the R2 station continue to read an AID11 of a next station information field. The rest may be deduced by analogy.

Optionally, a bit length of a subfield in which the first indication information is located may be one bit. For example, when a value of the subfield in which the first indication information is located is 1, it indicates that the NDPA frame is for OFDMA and non-OFDMA hybrid channel sounding. Optionally, when the value of the subfield in which the first indication information is located is 0, it indicates that the NDPA frame is for non-hybrid channel sounding. For example, when the NDPA frame is for non-hybrid channel sounding, format information in an NDP may indicate whether current channel sounding is OFMDA-based channel sounding or non-OFDMA-based channel sounding. For example, a PPDU type and compressed mode in the NDP may indicate whether current channel sounding is OFMDA-based channel sounding or non-OFDMA-based channel sounding.

Optionally, a bit length of a subfield in which the first indication information is located may be two bits. For example, when a value of the subfield in which the first indication information is located is 11, it indicates that the NDPA frame is for OFDMA and non-OFDMA hybrid channel sounding. For another example, when the value of the subfield in which the first indication information is located is 10, it indicates that the NDPA frame is for OFDMA channel sounding. For another example, when the value of the subfield in which the first indication information is located is 00, it indicates that the NDPA frame is for non-OFDMA channel sounding. It may be understood that the foregoing values of the subfield in which the first indication information is located and specific content corresponding to the values are merely examples, and should not be understood as a limitation on embodiments of the present disclosure.

As shown in FIG. 4a, in addition to the first indication information, the station information 1 field may further include the association identifier (association identifier 11, AID11) subfield, a partial bandwidth information (partial BW info) subfield, a reserved (reserved) subfield, a number of columns (Nc) index subfield, a feedback type and number of groups (Ng) (feedback type and Ng) subfield, a disambiguation (or disabled) subfield, a codebook size subfield, and a reserved (reserved) subfield. A number of bits occupied by each subfield may be shown in FIG. 4a. FIG. 4a shows only an example of the station information 1 field. For descriptions of a station information 2 field to the station information N field, adaptively refer to the station information 1 field. In addition, FIG. 4a further shows an example of other fields included in the NDPA frame. For example, the NDPA further includes a frame control (FC) field, a duration field, a receive address (RA) field, a transmit address (TA) field, a sounding dialog token field, and a frame check sequence (FCS) field. A number of octets occupied by other fields may be shown in FIG. 4a. For descriptions of other fields, refer to a related standard or protocol. Details are not described one by one in embodiments of the present disclosure. Implementation B:

The first indication information is carried in a specific station information field. The specific station information field includes an AID11 subfield, and a value of the AID11 subfield is a special value or a value reserved in a standard. For example, the value of the AID11 subfield in the specific station information field is a value greater than 2007, for example, any one of 2047, 2046, 2045, or the like, or may be a value that is pre-specified in a standard from 1 to 2007 and that is not allocated to any station. In other words, the value of the AID11 subfield in the specific station information field may be different from a value of the AID11 subfield shown in Implementation A. The value of the AID11 subfield in Implementation A indicates a second communication apparatus to obtain, based on a station information field in which the AID11 subfield is located, related information (such as related information in the station information 1 field shown in FIG. 4a) required for channel sounding. Compared with that in Implementation A, the value of the AID11 subfield in Implementation B indicates that each second communication apparatus may obtain, based on the specific station information field in which the AID11 subfield is located, some information (such as information in the specific station information field shown in FIG. 4b) required for channel sounding. For example, the some information may include the first indication information and a disallowed transmission subchannel bitmap shown below. For descriptions of the disallowed transmission subchannel bitmap, refer to the following. It should be noted that the disallowed transmission subchannel bitmap shown herein is merely an example, and when puncturing information of the second communication apparatus is indicated in another manner (for example, an implementation 2, and an implementation 4 to an implementation 9), the specific station information field may not include the disallowed transmission subchannel bitmap.

For example, content of the NDPA frame may be shown in FIG. 4b. The NDPA frame includes the specific station information field, the specific station information field includes the first indication information and the AID11 subfield, and the value of the AID11 subfield is any one of 2047, 2046, 2045, or the like. It may be understood that other special values are omitted in 2047/2046/2045 . . . shown in FIG. 4b, and all of the special values fall within the protection scope of embodiments of the present disclosure provided that the value of the AID11 subfield shown in FIG. 4b can be distinguished from the value of the AID11 subfield shown in FIG. 4a. It may be understood that a subfield other than the subfield in which the first indication information is located and the AID11 subfield in the specific station information field shown in FIG. 4b is not limited in embodiments of the present disclosure. For descriptions of the value of the subfield in which the first indication information is located, refer to descriptions in FIG. 4a.

It may be understood that for descriptions of a station information 1 field to a station information N field in the NDPA frame, adaptively refer to FIG. 4a. In addition, for descriptions of other fields in the NDPA frame shown in FIG. 4b, refer to FIG. 4a.

It should be noted that bit lengths of the subfield in which the first indication information is located shown in FIG. 4a and FIG. 4b are merely examples, and should not be understood as a limitation on embodiments of the present disclosure. For example, the bit length of the subfield in which the first indication information is located may alternatively be two bits, three bits, or the like. Examples are not enumerated herein.

302: The first communication apparatus sends an NDP, where a total bandwidth of the NDP is a first bandwidth, a corresponding NDP in the first bandwidth is used by the second communication apparatus to obtain channel state information between the second communication apparatus and the first communication apparatus, a corresponding NDP in a second bandwidth is used by the third communication apparatus to obtain channel state information between the third communication apparatus and the first communication apparatus, and the second bandwidth is a part of the first bandwidth.

Correspondingly, the second communication apparatus receives the NDP, and obtains the channel state information between the second communication apparatus and the first communication apparatus based on the first bandwidth. The third communication apparatus receives the NDP, and obtains the channel state information between the third communication apparatus and the first communication apparatus based on the second bandwidth.

In this embodiment, the first bandwidth is greater than 80 MHz. Optionally, the first bandwidth is a multiple of 80 MHz. It may be understood that the method shown in embodiments of the present disclosure is designed for channel sounding in a case in which preamble puncturing information exists. If preamble puncturing exists, a bandwidth of the NDP is greater than or equal to 80 MHz. In addition, because the NDP shown in embodiments of the present disclosure is not only used by the second communication apparatus to perform channel sounding, but also used by the third communication apparatus to perform channel sounding, the total bandwidth of the NDP is greater than 80 MHz.

Descriptions of the first bandwidth and the second bandwidth may further include: The first bandwidth is for OFDMA transmission, and the second bandwidth is for non-OFDMA transmission; or the first bandwidth is an OFDMA transmission part, and the second bandwidth is a non-OFDMA transmission part. For example, if a bandwidth other than the second bandwidth in the first bandwidth is referred to as a third bandwidth, the first bandwidth is for OFDMA transmission performed between the first communication apparatus and the second communication apparatus, the second bandwidth is for non-OFDMA transmission performed between the first communication apparatus and the third communication apparatus, and the third bandwidth may be used for OFDMA transmission or non-OFDMA transmission performed between the first communication apparatus and the second communication apparatus. It may be understood that, because the second bandwidth is included in the first bandwidth, that the second bandwidth is for non-OFDMA transmission performed between the first communication apparatus and the third communication apparatus may also be equivalent to that non-OFDMA transmission is performed between the first communication apparatus and the second communication apparatus. For the second communication apparatus, a bandwidth received by the second communication apparatus is the first bandwidth, and for the third communication apparatus, a bandwidth received by the third communication apparatus is the second bandwidth. Descriptions of the first bandwidth, the second bandwidth, and the third bandwidth are also applicable below.

The NDP shown in embodiments of the present disclosure includes an EHT sounding NDP, an NDP with another name that may appear in a subsequent standard, or the like. For example, the NDP is the EHT sounding NDP, the first communication apparatus is an AP, the second communication apparatus is an R2 station, and the third communication apparatus is an R1 station. In this case, the AP may send an EHT sounding NDP supporting an OFDMA puncturing pattern and an EHT sounding NDP supporting a non-OFDMA puncturing pattern, and a total bandwidth of each of the two EHT sounding NDPs is greater than 80 MHz and is a multiple of 80 MHz. For example, target stations of some 80 MHz channels may include the R1 station, and target stations of some 80 MHz channels may include only the R2 station. For another example, in one or more 80 MHz channels including the R1 station, the AP sends an EHT sounding NDP supporting non-OFDMA puncturing; and in one or more 80 MHz channels including only the R2 station, the AP may send an EHT sounding NDP supporting OFDMA puncturing, or may send an EHT sounding NDP supporting non-OFDMA puncturing. It may be understood that the EHT sounding NDP shown herein may be applicable to the 802.11be standard. In addition, the NDP shown in embodiments of the present disclosure is alternatively applicable to a standard later than 802.11be, and a specific name of the NDP used in the standard later than 802.11be is not limited in embodiments of the present disclosure.

It may be understood that the NDP shown in embodiments of the present disclosure may be understood as a physical layer protocol data unit (PPDU) without a data field part, or may be considered as a PPDU whose number of symbols in a data field is 0. Channel sounding in embodiments of the present disclosure may also be referred to as channel measurement, channel estimation, or the like. It may be understood that the NDP shown in embodiments of the present disclosure may be understood as one NDP, and different parts included in the NDP may be respectively represented as OFDMA-based channel sounding and non-OFDMA-based channel sounding. Alternatively, the NDP shown in embodiments of the present disclosure may be understood as a plurality of NDPs, and the plurality of NDPs are respectively represented as OFDMA-based channel sounding and non-OFDMA-based channel sounding.

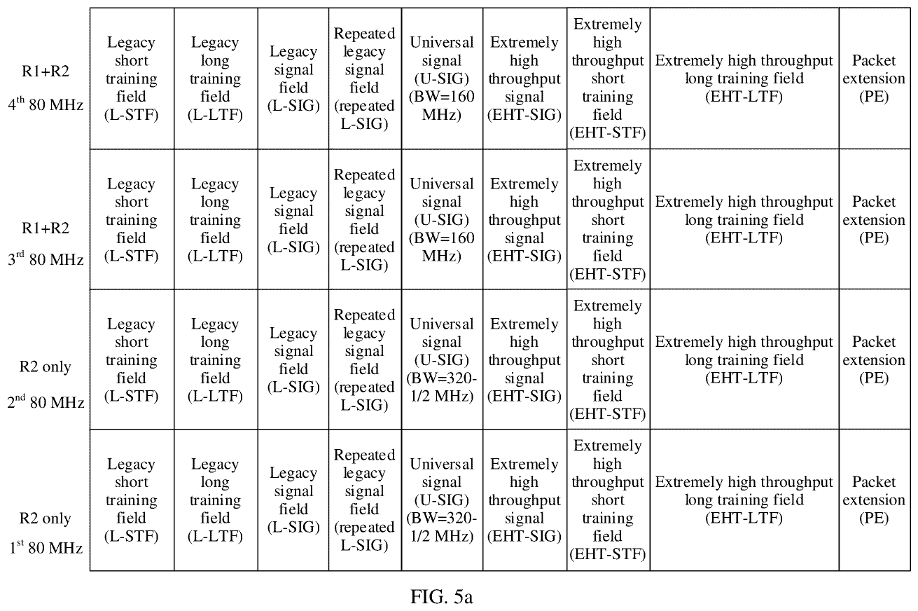

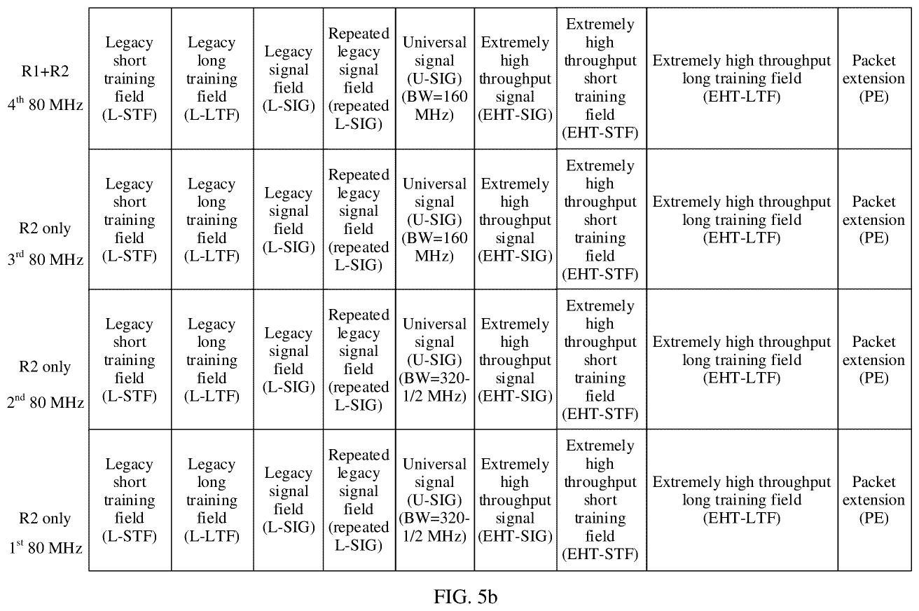

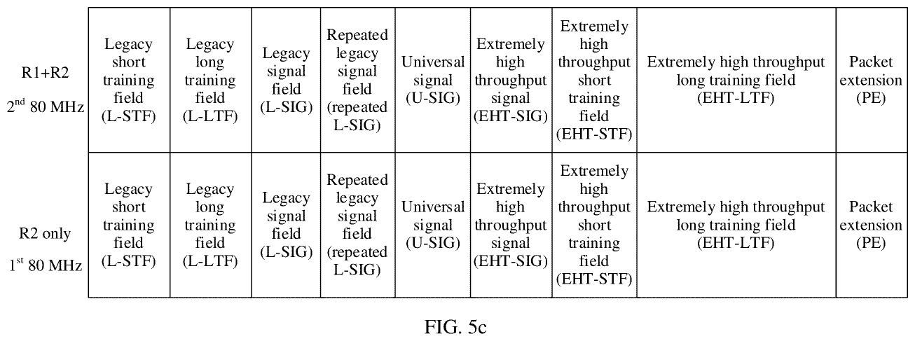

For example, FIG. 5a is a diagram of a structure of an NDP according to an embodiment of the present disclosure. As shown in FIG. 5a, a total bandwidth of the NDP is 320 MHz, a bandwidth including an R1 station is primary 160 MHz in the total bandwidth, that is, the second bandwidth is 160 MHz, and a bandwidth including an R2 station is 320 MHz, that is, the first bandwidth is 320 MHz. It may be understood that in FIG. 5a to FIG. 5c, frequencies increase sequentially from bottom to top. In FIG. 5a, a bandwidth of a primary channel is shown by using an example in which the bandwidth of the primary channel is located at a high frequency location in the total bandwidth. However, this should not be understood as a limitation on embodiments of the present disclosure. For example, the bandwidth of the primary channel may alternatively be located at a low frequency location of the total bandwidth.

In another example, FIG. 5b is a diagram of a structure of another NDP according to an embodiment of the present disclosure. As shown in FIG. 5b, a total bandwidth of the NDP is 320 MHz, a bandwidth including an R1 station is higher 80 MHz in the total bandwidth, that is, the second bandwidth is 80 MHz, and a bandwidth including an R2 station is 320 MHZ, that is, the first bandwidth is 320 MHz.

In still another example, FIG. 5c is a diagram of a structure of still another NDP according to an embodiment of the present disclosure. As shown in FIG. 5c, a total bandwidth of the NDP is 160 MHZ, a bandwidth including an R1 station is primary 80 MHz in the total bandwidth, that is, the second bandwidth is 80 MHz, and a bandwidth including an R2 station is 160 MHz, that is, the first bandwidth is 160 MHz.

FIG. 5a to FIG. 5c are used as examples. In a transmission part including the R1 station (such as an R1+R2 part shown in FIG. 5a to FIG. 5c), because the R1 station needs to obtain the corresponding NDP in the second bandwidth, the AP needs to send, in the corresponding NDP in the second bandwidth, a non-OFDMA puncturing pattern supported by the R1 station, as shown in an implementation 1 below. An EHT sounding NDP is used as an example. In this case, an EHT sounding NDP in the second bandwidth is for non-OFDMA transmission, and a target station includes the R1 station. Alternatively, the NDP in the second bandwidth may be referred to as a non-OFDMA-based NDP, and a puncturing pattern is a non-OFDMA pattern. An EHT sounding NDP in the first bandwidth is for OFDMA transmission, and a target station is the R2 station. Alternatively, the NDP in the first bandwidth may be referred to as an OFDMA-based NDP, and a puncturing pattern is an OFDMA pattern.

It may be understood that, because a puncturing pattern supported by a transmission part that includes the R1 station and the R2 station is a non-OFDMA puncturing pattern supported by the R1 station, the R1+R2 part shown in FIG. 5a to FIG. 5c may also be referred to as an R1 station part for short. For a transmission part that includes only the R2 station (such as R2 only shown in FIG. 5a to FIG. 5c), an OFDMA puncturing pattern supported by the R2 station may be designed, for example, an implementation 2 to an implementation 9 shown below. It should be noted that the non-OFDMA puncturing pattern may also be used for the transmission part that includes only the R2 station. For the non-OFDMA puncturing pattern supported by both the R1 station and the R2 station, refer to the implementation 1 shown below. For descriptions of the puncturing information, refer to the following. It may be understood that locations of a bandwidth including the R1 station shown in FIG. 5a to FIG. 5c are merely examples, and should not be understood as a limitation on embodiments of the present disclosure.

It should be noted that descriptions of a puncturing pattern supported by the NDP in the second bandwidth, a puncturing pattern supported by the NDP in the first bandwidth, an OFDMA-based NDP, a non-OFDMA-based NDP, and the like in embodiments of the present disclosure are also applicable below.

The following describes a location of the second bandwidth in the total bandwidth of the NDP.

In a possible implementation, the second bandwidth may be located on a primary channel of the total bandwidth of the NDP by default. For example, as specified in a standard or a protocol in advance, the second bandwidth may be located on the primary channel of the total bandwidth of the NDP.

In another possible implementation method, the NDPA frame may further include bandwidth information, where the bandwidth information indicates at least one of the first bandwidth or the second bandwidth. Optionally, the bandwidth information may indicate a bandwidth value of the entire bandwidth. Optionally, the bandwidth information may indicate the first bandwidth and the second bandwidth. Optionally, the bandwidth information may indicate the second bandwidth and the third bandwidth. Optionally, the bandwidth information further indicates at least one of location information of the second bandwidth or location information of the third bandwidth.

In an example, the bandwidth information may indicate, in an index manner, at least one of the first bandwidth, the second bandwidth, the third bandwidth, the location information of the second bandwidth, or the location information of the third bandwidth.

For example, a bit length of a subfield in which the bandwidth information is located is two bits. For example, 00 represents 80-80, 01 represents 80-240, 10 represents 240-80, and 11 represents 160-160. It may be understood that relationships between a value of two bits and a bandwidth shown in embodiments of the present disclosure are merely examples, and should not be understood as a limitation on embodiments of the present disclosure.

In current channel sounding, the R1 station is located on the primary channel. Therefore, the location of the second bandwidth may not need to be additionally indicated.

For example, 80-80 may indicate that the second bandwidth and the third bandwidth are respectively 80 MHz and 80 MHz, and the first bandwidth is 160 MHz. The second bandwidth is located in primary 80 MHz, and the third bandwidth is located in secondary 80 MHz.

80-240 may indicate that the second bandwidth and the third bandwidth are respectively 80 MHz and 240 MHz, and the first bandwidth is 320 MHz. The second bandwidth is located in primary 80 MHz, and the third bandwidth is located on another 240 MHz channel in 320 MHz other than the second bandwidth.

240-80 may indicate that the second bandwidth and the third bandwidth are respectively 240 MHz and 80 MHz, and the first bandwidth is 320 MHz. The second bandwidth is located on a 240 MHz channel on which primary 160 MHz is located, and the third bandwidth is located on an 80 MHz channel in 320 MHz other than the second bandwidth. There are two cases of the 240 MHz channel, which respectively include a low-frequency 80 MHz channel or a high-frequency 80 MHz channel in a secondary 160 MHz channel. The two cases may be considered as one case in a standard by default, or there are two different entries that are separately indicated.

160-160 may indicate that the second bandwidth and the third bandwidth are respectively 160 MHz and 160 MHz, and the first bandwidth is 320 MHz. The second bandwidth is located in 160 MHz, and the third bandwidth is located in secondary 160 MHz.

In another method, the bandwidth information may indicate both sizes and locations of the second bandwidth and the third bandwidth. For example, a relationship between a value (namely, an index) of a subfield in which the bandwidth information is located and content expressed by the value may be shown in Table 1a.

TABLE 1a

| Index | Content | Description |
|---|---|---|
| 0 | 80-80-L | The R1 station is located in lower 80 MHz |
| 1 | 80-80-H | The R1 station is located in higher 80 MHz |
| 2 | 80-240-L | The R1 station is located in lower 80 MHz |
| 3 | 80-240-H | The R1 station is located in higher 80 MHz |
| 4 | 240-80-L | The R1 station is located in lower 240 MHz |
| 5 | 240-80-H | The R1 station is located in higher 240 MHz |
| 6 | 160-160-L | The R1 station is located in lower 160 MHz |
| 7 | 160-160-H | The R1 station is located in higher 160 MHz |

For example, if the index of the subfield in which the bandwidth information is located is 0, it indicates that the R1 station is located in lower 80 MHz of the total bandwidth, and a part that includes only the R2 station is located in higher 80 MHz of the total bandwidth. Descriptions of other indexes are not enumerated herein. It may be understood that the relationship between the index and the content shown in Table 1a is merely an example, and should not be understood as a limitation on embodiments of the present disclosure.

In another example, the bandwidth information may indicate the first bandwidth, the second bandwidth, and location information in a bitmap manner. For example, a bitmap indicates 80 MHz in which the second bandwidth is located and 80 MHz in which the third bandwidth is located. For example, the bit length of the subfield in which the bandwidth information is located is four bits. For example, 1100 indicates that in ascending order of frequencies in 320 MHz, first two 80 MHz are the second bandwidth, and last two 80 MHz are the third bandwidth. For another example, 1100 indicates that in descending order of frequencies in 320 MHz, first two 80 MHz are the second bandwidth, and last two 80 MHz are the third bandwidth. For another example, the bit length of the subfield in which the bandwidth information is located is two bits. For example, the third bandwidth is indicated by using two bits.

For example, the subfield in which the bandwidth information is located may be carried in the reserved field in the station information field shown in FIG. 4a. For example, the subfield in which the bandwidth information is located may be carried in the specific station information field shown in FIG. 4b. For example, the subfield in which the bandwidth information is located is located in a reserved field shown in FIG. 4b. For another example, when the bit length of the subfield in which the bandwidth information is located is four bits, the specific station information field shown in FIG. 4b may not include the disallowed transmission subchannel bitmap, or a bit length of the disallowed transmission subchannel bitmap is less than 16 bits. A specific location of the bandwidth information in the NDPA frame is not limited in embodiments of the present disclosure.

It may be understood that the foregoing implementations may also be combined with each other. For example, if the bandwidth information indicates the first bandwidth, the second bandwidth may be a primary bandwidth of the first bandwidth by default. For another example, if the bandwidth information indicates the first bandwidth and the second bandwidth, a location of the second bandwidth may be a primary channel by default. Examples are not enumerated herein.

NDPs shown in FIG. 5a to FIG. 5c may be described as follows:

As shown in FIG. 5a to FIG. 5c, the NDP includes a legacy short training field (L-STF), a legacy long training field (L-LTF), and a legacy signal field (L-SIG). The L-STF, the L-LTF, and the L-SIG are used to ensure coexistence between a new device and a conventional device. The L-SIG includes a length field that may indirectly indicate duration of a subsequent part of the L-SIG in the NDP. In addition, the NDP further includes a repeated legacy signal field (repeated L-SIG, RL-SIG) that is used to enhance reliability of the legacy signal field, and the like. In addition, the NDP further includes a universal signal (U-SIG) field, extremely high throughput signal (EHT-SIG), an extremely high throughput short training field (EHT-STF), an extremely high throughput long training field (EHT-LTF), and a packet extension (PE) field. For example, the U-SIG field may exist in the 802.11be standard and several subsequent generations of the 802.11be standard. For example, the U-SIG field may further indicate that a PPDU (that is, a PPDU without a data field) is an EHT PPDU or a PPDU in a subsequent generation standard. The EHT-SIG field may be used to carry signal information required for demodulating a subsequent field. For descriptions of puncturing information included in the U-SIG field or the EHT-SIG field in the NDP, refer to the following. For descriptions of other fields in the NDP, refer to a related standard or protocol.

In a possible implementation, the method shown in FIG. 3 further includes a step 303 and a step 304.

303: The first communication apparatus sends a trigger frame; and correspondingly, the second communication apparatus receives the trigger frame, and the third communication apparatus receives the trigger frame.

304: The second communication apparatus sends a first beamforming report to the first communication apparatus, and the third communication apparatus sends a second beamforming report to the first communication apparatus. Correspondingly, the first communication apparatus receives the first beamforming report and the second beamforming report.

The first beamforming report indicates the channel state information in the first bandwidth, and the second beamforming report indicates the channel state information in the second bandwidth. In other words, the first beamforming report indicates the channel state information between the first communication apparatus and the second communication apparatus, and the second beamforming report indicates the channel state information between the first communication apparatus and the third communication apparatus. After obtaining the first beamforming report and the second beamforming report, the first communication apparatus may perform beamforming and resource scheduling.

In this embodiment, the first communication apparatus may simultaneously perform channel sounding with the second communication apparatus and the third communication apparatus, so that the first communication apparatus can obtain the channel state information between the first communication apparatus and the second communication apparatus and the channel state information between the first communication apparatus and the third communication apparatus in one channel sounding procedure. This not only improves channel utilization, but also improves channel sounding efficiency.

The following uses an example to describe a procedure of the channel sounding method provided in embodiments of the present disclosure.

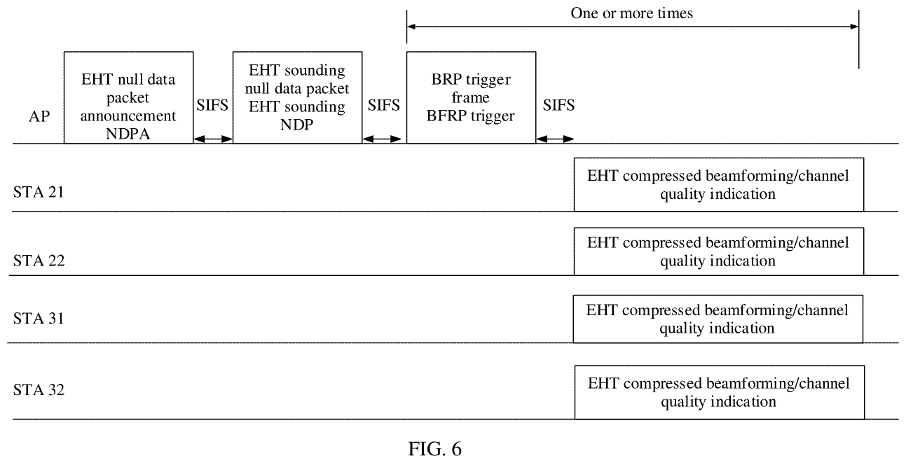

FIG. 6 is a diagram of a trigger-based (TB) EHT channel sounding method according to an embodiment of the present disclosure. The EHT channel sounding method provided in this embodiment is described by using an example in which an AP is a beamformer, and a STA 21, a STA 22, a STA 31, and a STA 32 are beamformees. The STA 21 and the STA 22 shown in FIG. 6 may be understood as two second communication apparatuses, and the STA 31 and the STA 32 may be understood as two third communication apparatuses. That is, “21”, “22”, “31”, and “32” are used to distinguish between different STAs. It may be understood that the two second communication apparatuses and the two third communication apparatuses shown in FIG. 6 are merely examples, and there may be more or fewer second communication apparatuses or third communication apparatuses. This is not limited in this embodiment. For example, the first communication apparatus may initiate a channel sounding procedure to one third communication apparatus and a plurality of second communication apparatuses, or the first communication apparatus may initiate a channel sounding procedure to one second communication apparatus and a plurality of third communication apparatuses. Examples are not enumerated herein.

As shown in FIG. 6, the AP separately sends an EHT NDPA frame to the STA 21, the STA 22, the STA 31, and the STA 32, and indicates a related parameter of EHT channel sounding by using the EHT NDPA frame. For first indication information included in the EHT NDPA frame, refer to FIG. 4a and FIG. 4b. FIG. 4a is used as an example. In this case, in the EHT NDPA frame, a station information field corresponding to the STA 21 and a station information field corresponding to the STA 22 may include the first indication information. In this way, the station information field corresponding to the STA 21 indicates that current channel sounding of the STA 21 is hybrid channel sounding, and the station information field corresponding to the STA 22 indicates that current channel sounding of the STA 22 is hybrid channel sounding. FIG. 4b is used as an example. A specific station information field in the EHT NDPA frame includes the first indication information, so that the specific station information field indicates that current channel sounding of the STA 21 and current channel sounding of the STA 22 are hybrid channel sounding.

Then, after a short interframe space (SIFS), the AP separately sends an EHT sounding NDP to the STA 21, the STA 22, the STA 31, and the STA 32. The STA 21, the STA 22, the STA 31, and the STA 32 separately perform channel estimation based on the EHT sounding NDP. For example, the STA 21 obtains channel state information between the STA 21 and the AP based on a total bandwidth of the EHT sounding NDP, the STA 22 obtains channel state information between the STA 22 and the AP based on the total bandwidth of the EHT sounding NDP, the STA 31 obtains channel state information between the STA 31 and the AP based on a second bandwidth of the EHT sounding NDP, and the STA 32 obtains channel state information between the STA 32 and the AP based on the second bandwidth of the EHT sounding NDP. Therefore, the STA 21, the STA 22, the STA 31, and the STA 32 separately feed back an EHT compressed beamforming/channel quality indication (CQI) frame. The EHT compressed beamforming/channel quality indication frame may also be referred to as a beamforming report. Because the STA 21 and the STA 22 obtain channel state information in the entire bandwidth, and the STA 31 and the STA 32 obtain channel state information in the second bandwidth, beamforming reports fed back by the STA 21 and the STA 22 may also be referred to as first beamforming reports, beamforming reports fed back by the STA 31 and the STA 32 may also be referred to as second beamforming reports. Although beamforming reports are not distinguished in FIG. 6, it should not be understood as a limitation on embodiments of the present disclosure.

As shown in FIG. 6, after separately sending the EHT sounding NDP to the STA 21, the STA 22, the STA 31, and the STA 32, the AP may further separately send a beamforming report poll trigger frame (BFRP TF) to the STA 21, the STA 22, the STA 31, and the STA 32 after one SIFS, to trigger a plurality of beamformees to perform channel sounding. Optionally, each time the AP sends a trigger frame, the AP may trigger one beamformee to feed back a beamforming report. Optionally, each time the AP sends a trigger frame, the AP may simultaneously trigger the plurality of beamformees shown in FIG. 6 to feed back beamforming reports. Optionally, each time the AP sends a trigger frame, the AP may simultaneously trigger beamformees of a same type to feed back beamforming reports. For example, after sending the NDP, the AP sends a trigger frame after one SIFS. The trigger frame is used to trigger the STA 21 and the STA 22 to feed back beamforming reports. Then, the AP sends a trigger frame after one SIFS. The trigger frame is used to trigger the STA 31 and the STA 32 to feed back beamforming reports. It may be understood that a function of the trigger frame is not limited in embodiments of the present disclosure.

It may be understood that for descriptions of the EHT NDPA frame and the EHT sounding NDP, refer to the foregoing descriptions, or refer to the following descriptions.

According to the hybrid channel sounding method provided in this embodiment, the STA 21, the STA 22, the STA 31, and the STA 32 may simultaneously feed back channel state information. This effectively improves a case in which an OFDMA-based STA and a non-OFDMA-based STA need to feed back channel state information only in different channel sounding procedures, and not only improves channel utilization, but also improves channel sounding efficiency.

In the methods shown in FIG. 3 and FIG. 6, when the second communication apparatus and the third communication apparatus feed back channel state information, the second communication apparatus and the third communication apparatus cannot feed back channel state information of a punctured subchannel. Therefore, the second communication apparatus needs to obtain puncturing information in the first bandwidth, and the third communication apparatus needs to obtain puncturing information in the second bandwidth. A punctured subchannel indicates that the subchannel is occupied or the subchannel is in a busy state. The puncturing information shown in embodiments of the present disclosure may also be referred to as preamble puncturing information, a preamble puncturing status, or the like, and the puncturing information indicates a puncturing pattern, or the puncturing information indicates a puncturing pattern of an EHT sounding NDP.

The following describes in detail the puncturing information in embodiments of the present disclosure.

For descriptions of puncturing information of non-OFDMA supported by the R1 station and the R2 station, refer to the following implementation 1. For descriptions of puncturing information of OFDMA supported by the R2 station, refer to the following implementation 2 to implementation 9.

For ease of differentiation, in embodiments of the present disclosure, a U-SIG field in an NDP in the second bandwidth is referred to as a second U-SIG field, an EHT-SIG field in the NDP in the second bandwidth is referred to as a second EHT-SIG field, a U-SIG field in an NDP in the third bandwidth is referred to as a first U-SIG field, and an EHT-SIG field in the NDP in the third bandwidth is referred to as a first EHT-SIG field.

The following describes non-OFDMA-based puncturing information in detail.

### Implementation 1:

An NDP includes a second U-SIG field, where the second U-SIG field includes fourth indication information and second format information, the fourth indication information indicates puncturing information in the second bandwidth, and the second format information indicates that the NDP in the second bandwidth is a non-OFDMA-based NDP.

For example, the fourth indication information may be carried in a puncturing information indication field, for example, B3 to B7, in a second symbol in the second U-SIG field. The second format information may be carried in a PPDU type and compressed mode field, for example, B0 and B1, in the second symbol in the second U-SIG field. Puncturing information indicated by the puncturing information indication field may be shown in Table 1b. 320 MHz shown in FIG. 5a is used as an example, and puncturing information of a transmission part that includes the R1 station is [x x 1 1 1 1 1 1]. In this case, a value of a bandwidth field in a first symbol in the second U-SIG field is 3 (indicating that BW=160 MHz), a value of the puncturing information indication field in the second symbol in the second U-SIG field is 9, and a value of the PPDU type and compressed mode field in the second symbol in the second U-SIG field may be 1. It may be understood that when the value of the PPDU type and compressed mode field indicates 1, an EHT-SIG modulation and coding scheme (MCS) field is set to 0, and a number of EHT-SIG symbols field is set to 0 (indicating one symbol), it indicates an NDP. Because there is less content in information in an EHT-SIG field in an EHT sounding NDP than content in another data transmission field. Only the EHT sounding NDP can ensure that a number of EHT-SIG symbols is 1 when the EHT-SIG MCS field is 0. It may be understood that for descriptions of other fields in the NDP in the second bandwidth, refer to FIG. 5a to FIG. 5c, or refer to a related standard, protocol, or the like.

TABLE 1b

| | | | Puncturing pattern | |
|---|---|---|---|---|
| PPDU | | | (resource unit or | |
| bandwidth | | | multiple resource unit | Field |
| (BW) | | Cases | index (RU or MRU index)) | value |
| 20 | MHz | No | [1] | 0 |
| | | puncturing | (242-tone RU 1) | |
| 40 | MHz | No | [1 1] | 0 |
| | | puncturing | (484-tone RU 1) | |
| 80 | MHz | No | [1 1 1 1] | 0 |
| | | puncturing | (996-tone RU 1) | |
| | | 20 MHz is | [x 1 1 1] | 1 |
| | | punctured | (484 + 242-tone MRU 1) | |
| | | | [1 x 1 1] | 2 |
| | | | (484 + 242-tone MRU 2) | |
| | | | [1 1 x 1] | 3 |
| | | | (484 + 242-tone MRU 3) | |
| | | | [1 1 1 x] | 4 |
| | | | (484 + 242-tone MRU 4) | |
| 160 | MHz | No | [1 1 1 1 1 1 1 1] | 0 |
| | | puncturing | (2 × 996-tone RU 1) | |
| | | 20 MHz is | [x 1 1 1 1 1 1 1] | 1 |
| | | punctured | (996 + 484 + 242-tone MRU 1) | |
| | | | [1 x 1 1 1 1 1 1] | 2 |
| | | | (996 + 484 + 242-tone MRU 2) | |
| | | | [1 1 x 1 1 1 1 1] | 3 |
| | | | (996 + 484 + 242-tone MRU 3) | |
| | | | [1 1 1 x 1 1 1 1] | 4 |
| | | | (996 + 484 + 242-tone MRU 4) | |
| | | | [1 1 1 1 x 1 1 1] | 5 |
| | | | (996 + 484 + 242-tone MRU 5) | |
| | | | [1 1 1 1 1 x 1 1] | 6 |
| | | | (996 + 484 + 242-tone MRU 6) | |
| | | | [1 1 1 1 1 1 x 1] | 7 |
| | | | (996 + 484 + 242-tone MRU 7) | |
| | | | [1 1 1 1 1 1 1 x] | 8 |
| | | | (996 + 484 + 242-tone MRU 8) | |
| | | 40 MHz is | [x x 1 1 1 1 1 1] | 9 |
| | | punctured | (996 + 484-tone MRU 1) | |
| | | | [1 1 x x 1 1 1 1] | 10 |
| | | | (996 + 484-tone MRU 2) | |
| | | | [1 1 1 1 x x 1 1] | 11 |
| | | | (996 + 484-tone MRU 3) | |
| | | | [1 1 1 1 1 1 x x] | 12 |
| | | | (996 + 484-tone MRU 4) | |
| 320 | MHz | No | [1 1 1 1 1 1 1 1] | 0 |
| | | puncturing | (4 × 996-tone RU 1) | |
| | | 40 MHz is | [x 1 1 1 1 1 1 1] | 1 |
| | | punctured | (3 × 996 + 484-tone MRU 1) | |
| | | | [1 x 1 1 1 1 1 1] | 2 |
| | | | (3 × 996 + 484-tone MRU 2) | |
| | | | [1 1 x 1 1 1 1 1] | 3 |
| | | | (3 × 996 + 484-tone MRU 3) | |
| | | | [1 1 1 x 1 1 1 1] | 4 |
| | | | (3 × 996 + 484-tone MRU 4) | |
| | | | [1 1 1 1 x 1 1 1] | 5 |
| | | | (3 × 996 + 484-tone MRU 5) | |
| | | | [1 1 1 1 1 x 1 1] | 6 |
| | | | (3 × 996 + 484-tone MRU 6) | |
| | | | [1 1 1 1 1 1 x 1] | 7 |
| | | | (3 × 996 + 484-tone MRU 7) | |
| | | | [1 1 1 1 1 1 1 x] | 8 |
| | | | (3 × 996 + 484-tone MRU 8) | |
| | | 80 MHz is | [x x 1 1 1 1 1 1] | 9 |
| | | punctured | (3 × 996-tone MRU 1) | |
| | | | [1 1 x x 1 1 1 1] | 10 |
| | | | (3 × 996-tone MRU 2) | |
| | | | [1 1 1 1 x x 1 1] | 11 |
| | | | (3 × 996-tone MRU 3) | |
| | | | [1 1 1 1 1 1 x x] | 12 |
| | | | (3 × 996-tone MRU 4) | |
| | | 80 MHz and | [x x x 1 1 1 1 1] | 13 |
| | | 40 MHz in | (2 × 996 + 484-tone MRU 7) | |
| | | 320 MHz are | [x x 1 x 1 1 1 1] | 14 |
| | | punctured | (2 × 996 + 484-tone MRU 8) | |
| | | | [x x 1 1 x 1 1 1] | 15 |
| | | | (2 × 996 + 484-tone MRU 9) | |
| | | | [x x 1 1 1 x 1 1] | 16 |
| | | | (2 × 996 + 484-tone MRU 10) | |
| | | | [x x 1 1 1 1 x 1] | 17 |
| | | | (2 × 996 + 484-tone MRU 11) | |
| | | | [x x 1 1 1 1 1 x] | 18 |
| | | | (2 × 996 + 484-tone MRU 12) | |
| | | | [x 1 1 1 1 1 x x] | 19 |
| | | | (2 × 996 + 484-tone MRU 1) | |
| | | | [1 x 1 1 1 1 x x] | 20 |
| | | | (2 × 996 + 484-tone MRU 2) | |
| | | | [1 1 x 1 1 1 x x] | 21 |
| | | | (2 × 996 + 484-tone MRU 3) | |
| | | | [1 1 1 x 1 1 x x] | 22 |
| | | | (2 × 996 + 484-tone MRU 4) | |
| | | | [1 1 1 1 x 1 x x] | 23 |
| | | | (2 × 996 + 484-tone MRU 5) | |
| | | | [1 1 1 1 1 x x x] | 24 |
| | | | (2 × 996 + 484-tone MRU 6) | |

In Table 1b, one “1” represents one nonpunctured subchannel, and one “x” represents one punctured subchannel. For an 80 MHz PPDU and a 160 MHz PPDU, a puncturing granularity is 20 MHz (each “1” or “x” represents a 20 MHz subchannel). For a 320 MHz PPDU, a puncturing granularity is 40 MHz (each “1” or “x” represents a 40 MHz subchannel). In Table 1b, frequencies increase from left to right. It may be understood that an entry that does not appear in Table 1b may be understood as one of validate or reserved. For descriptions of Table 1b, refer to a related standard or protocol.

In embodiments of the present disclosure, the first bandwidth is for OFDMA transmission. That is, an NDP in the first bandwidth is used by the second communication apparatus to obtain the channel state information between the second communication apparatus and the first communication apparatus. In the first bandwidth, the second communication apparatus may perform OFDMA transmission-based channel sounding, the second communication apparatus can perform OFDMA transmission channel sounding based on the NDP, or the NDP may be an OFDMA-based EHT sounding NDP for channel sounding. That is, the NDP in the first bandwidth is OFDMA-based puncturing information. An NDP in the third bandwidth may be used for both OFDMA transmission and non-OFDMA transmission. For descriptions of non-OFDMA-based puncturing information, refer to the implementation 1. For descriptions of OFDMA-based puncturing information, refer to the implementation 2 to the implementation 9. An example is used to describe a case in which the NDP in the first bandwidth is the OFDMA-based puncturing information, and both the NDP in the second bandwidth and the NDP in the third bandwidth are the non-OFDMA-based puncturing information. For example, puncturing information of the NDP in the second bandwidth is [1111 1100] (for example, [1111 11xx] shown in Table 1b), and puncturing information of the NDP in the third bandwidth is also [1111 1100]. In this case, puncturing information of the NDP in the first bandwidth is [1111 1100 1111 1100], which is a puncturing pattern supported in OFDMA.

The following describes the OFDMA-based puncturing information in detail.

In a first manner, the NDPA frame further includes second indication information, where the second indication information indicates the puncturing information in the first bandwidth.

Implementation 2: The second indication information is carried in a partial bandwidth information subfield in a station information field.

The partial bandwidth information subfield is one 9-bit bitmap, and indicates a corresponding station to feed back channel state information of a partial bandwidth. A resolution subfield indicates to a size of a subchannel corresponding to each bit in a feedback bitmap, and a value of the resolution subfield may be determined based on a size of the first bandwidth. Each bit in a subsequent 8-bit bitmap indicates whether channel state information corresponding to each subchannel in the entire bandwidth needs to be fed back. It may be understood that a subchannel whose channel state information needs to be fed back is a nonpunctured subchannel. Therefore, the second indication information may be implemented by using the feedback bitmap in the partial bandwidth information subfield. That is, the second indication information may indicate the puncturing information in the first bandwidth, and may also indicate the second communication apparatus to feed back channel state information of a nonpunctured subchannel in the first bandwidth (which may also be referred to as indicating a subchannel whose channel state information needs to be fed back by the second communication apparatus). For example, in the partial bandwidth information subfield, a punctured 20 MHz subchannel or a punctured 40 MHz subchannel indicates 0, and a nonpunctured 20 MHz subchannel or a nonpunctured 40 MHz subchannel may indicate 1 or 0 based on whether channel state information of the subchannel needs to be fed back by the second communication apparatus. In other words, a channel whose channel state information needs to be requested by the first communication apparatus may be represented as a nonpunctured channel, which is equivalent to an implicit puncturing indication manner. In other words, a request mode shown in embodiments of the present disclosure may not necessarily be non-OFDMA puncturing. Therefore, when an NDP is subsequently transmitted in an OFDMA mode in the first bandwidth and transmitted in a non-OFDMA mode in the second bandwidth, a beamforming report on a required subchannel may still be fed back. Optionally, the puncturing information may be further indicated more flexibly. For example, when the resolution field indicates is 1, and eight bits in the feedback bitmap indicate 01111111, it may indicate that a puncturing pattern of a bandwidth of a 320 MHz EHT sounding NDP is [0011111111111111]. If “1” indicates that no puncturing is performed, and “0” indicates that puncturing is performed, the foregoing puncturing pattern indicates that a first 40 MHz subchannel in a 320 MHz bandwidth is punctured, and a second 40 MHz channel to an eighth 40 MHz channel are not punctured. For another example, when the resolution field indicates 0, and eight bits in the feedback bitmap indicate 01111111, it indicates that a puncturing pattern of a bandwidth of a 160 MHz EHT sounding NDP is [01111111]. In other words, in a 160 MHz bandwidth, a first 20 MHz subchannel is punctured, and a second 20 MHz channel to an eighth 20 MHz channel are not punctured.

It may be understood that for specific descriptions of the NDPA frame, refer to FIG. 4a.

Implementation 3: The second indication information is carried in a specific station information field.

The NDPA frame shown in FIG. 4b is used as an example. The specific station information field may include a disallowed transmission subchannel bitmap. That is, the second indication information may be implemented by using the disallowed transmission subchannel bitmap. The disallowed transmission subchannel bitmap indicates a subchannel on which transmission is disallowed in the first bandwidth. Therefore, each second communication apparatus can obtain the puncturing information in the first bandwidth by using the disallowed transmission subchannel bitmap.

Optionally, a size of the disallowed transmission subchannel bitmap is 16 bits (for example, B0 to B15). First eight bits (for example, B0 to B7) of the disallowed transmission subchannel bitmap may indicate a puncturing status of a corresponding subchannel in a primary 160 MHz channel of the first bandwidth, and last eight bits (B8 to B15) of the disallowed transmission subchannel bitmap may indicate a puncturing status of a corresponding subchannel in a secondary 160 MHz channel of the first bandwidth. In this way, the first eight bits of the disallowed transmission subchannel bitmap may indicate primary 160 MHZ, indications of first eight bits of disallowed transmission subchannel bitmaps of an HE NDPA frame and an EHT NDPA frame may be consistent, and procedures of parsing the HE NDPA frame and the EHT NDPA frame by a Bfee may be the same, thereby reducing implementation complexity of a receiver. For example, when the disallowed transmission subchannel bitmap indicates 1101111111111001, it indicates that a puncturing pattern of a 320 MHz first bandwidth is [1101111111111001], and each bit indicates whether a 20 MHz subchannel is punctured. If “1” indicates that no puncturing is performed, and “0” indicates that puncturing is performed, the foregoing puncturing pattern indicates that a subchannel 3, a subchannel 14, and a subchannel 15 are punctured in the first bandwidth, and a subchannel 1, a subchannel 2, a subchannel 4 to a subchannel 13, and a subchannel 16 are not punctured in the first bandwidth.

Optionally, an i^{th} bit in the disallowed transmission subchannel bitmap may indicate a puncturing status of an i^{th} channel in the first bandwidth, where i is an integer, 1≤i≤a number of channels in the first bandwidth, and the channels in the first bandwidth are arranged in ascending order of frequencies. In this way, implementation logic can be simplified. For example, when the disallowed transmission subchannel bitmap indicates 1101111111111001, it indicates that a puncturing pattern of a 320 MHz first bandwidth is [1101111111111001], a subchannel 3, a subchannel 14, and a subchannel 15 are punctured, and a subchannel 1, a subchannel 2, a subchannel 4 to a subchannel 13, and a subchannel 16 are not punctured.

It may be understood that the foregoing bit length of the disallowed transmission subchannel bitmap is merely an example. For example, the bit length of the disallowed transmission subchannel bitmap may alternatively be eight bits. For example, when the first bandwidth is 320 MHZ, each bit may indicate whether each 40 MHz is punctured. For example, when the first bandwidth is 160 MHz, each bit may indicate whether each 20 MHz is punctured.

The foregoing uses an example in which the puncturing information is included in the NDPA frame. The second indication information is included in the station information field or the specific station information field, so that the second communication apparatus not only learns of, based on the NDPA frame, that current channel sounding is hybrid channel sounding, but also learns of the puncturing information in the first bandwidth.

It should be noted that when the NDPA frame includes the puncturing information in the first bandwidth, the second communication apparatus may learn of puncturing information in the entire bandwidth based on the NDPA frame. Optionally, the second communication apparatus may read neither puncturing information in a first U-SIG field nor puncturing information in a first EHT-SIG field in the NDP. For example, when performing channel estimation based on the NDP, the second communication apparatus may obtain, based on the second indication information stored in the NDPA frame, puncturing information of a subchannel, any first U-SIG field, and any first EHT-SIG field, to perform channel estimation, and perform channel feedback. Optionally, a puncturing information indication field in the first U-SIG field may be further set to a first special value, to indicate the second communication apparatus to obtain the puncturing information in the first bandwidth by using the NDPA frame and not to carry a puncturing pattern through an EHT sounding NDP. With reference to Table 1b, an example in which a value of the puncturing information indication field in the first U-SIG field is 31 is used, as shown in Table 2. When obtaining the first U-SIG field, the second communication apparatus may learn of, based on the value of the puncturing information indication field in the first U-SIG field, that puncturing information in the entire bandwidth is determined based on the second indication information in the NDPA frame. It may be understood that for descriptions of Table 2, refer to Table 1b. 31 shown above is merely an example, and should not be understood as a limitation on embodiments of the present disclosure. Alternatively, the first special value shown above may alternatively be any value from 25 to 30.

TABLE 2

| | | | Puncturing pattern | |
|---|---|---|---|---|
| PPDU | | | (resource unit or | |
| bandwidth | | | multiple resource unit | Field |
| (BW) | | Cases | index (RU or MRU index)) | value |
| 20 | MHz | No | [1] | 0 |
| | | puncturing | (242-tone RU 1) | |
| 40 | MHz | No | [1 1] | 0 |
| | | puncturing | (484-tone RU 1) | |
| 80 | MHz | No | [1 1 1 1] | 0 |
| | | puncturing | (996-tone RU 1) | |
| | | 20 MHz is | [x 1 1 1] | 1 |
| | | punctured | (484 + 242-tone MRU 1) | |
| | | | [1 x 1 1] | 2 |
| | | | (484 + 242-tone MRU 2) | |
| | | | [1 1 x 1] | 3 |
| | | | (484 + 242-tone MRU 3) | |
| | | | [1 1 1 x] | 4 |
| | | | (484 + 242-tone MRU 4) | |
| | | Specific puncturing pattern | | 31 |
| 160 | MHz | No | [1 1 1 1 1 1 1 1] | 0 |
| | | puncturing | (2 × 996-tone RU 1) | |
| | | 20 MHz is | [x 1 1 1 1 1 1 1] | 1 |
| | | punctured | (996 + 484 + 242-tone MRU 1) | |
| | | | [1 x 1 1 1 1 1 1] | 2 |
| | | | (996 + 484 + 242-tone MRU 2) | |
| | | | [1 1 x 1 1 1 1 1] | 3 |
| | | | (996 + 484 + 242-tone MRU 3) | |
| | | | [1 1 1 x 1 1 1 1] | 4 |
| | | | (996 + 484 + 242-tone MRU 4) | |
| | | | [1 1 1 1 x 1 1 1] | 5 |
| | | | (996 + 484 + 242-tone MRU 5) | |
| | | | [1 1 1 1 1 x 1 1] | 6 |
| | | | (996 + 484 + 242-tone MRU 6) | |
| | | | [1 1 1 1 1 1 x 1] | 7 |
| | | | (996 + 484 + 242-tone MRU 7) | |
| | | | [1 1 1 1 1 1 1 x] | 8 |
| | | | (996 + 484 + 242-tone MRU 8) | |
| | | 40 MHz is | [x x 1 1 1 1 1 1] | 9 |
| | | punctured | (996 + 484-tone MRU 1) | |
| | | | [1 1 x x 1 1 1 1] | 10 |
| | | | (996 + 484-tone MRU 2) | |
| | | | [1 1 1 1 x x 1 1] | 11 |
| | | | (996 + 484-tone MRU 3) | |
| | | | [1 1 1 1 1 1 x x] | 12 |
| | | | (996 + 484-tone MRU 4) | |
| | | Specific puncturing pattern | | 31 |
| 320 | MHz | No | [1 1 1 1 1 1 1 1] | 0 |
| | | puncturing | (4 × 996-tone RU 1) | |
| | | 40 MHz is | [x 1 1 1 1 1 1 1] | 1 |
| | | punctured | (3 × 996 + 484-tone MRU 1) | |
| | | | [1 x 1 1 1 1 1 1] | 2 |
| | | | (3 × 996 + 484-tone MRU 2) | |
| | | | [1 1 x 1 1 1 1 1] | 3 |
| | | | (3 × 996 + 484-tone MRU 3) | |
| | | | [1 1 1 x 1 1 1 1] | 4 |
| | | | (3 × 996 + 484-tone MRU 4) | |
| | | | [1 1 1 1 x 1 1 1] | 5 |
| | | | (3 × 996 + 484-tone MRU 5) | |
| | | | [1 1 1 1 1 x 1 1] | 6 |
| | | | (3 × 996 + 484-tone MRU 6) | |
| | | | [1 1 1 1 1 1 x 1] | 7 |
| | | | (3 × 996 + 484-tone MRU 7) | |
| | | | [1 1 1 1 1 1 1 x] | 8 |
| | | | (3 × 996 + 484-tone MRU 8) | |
| | | 80 MHz is | [x x 1 1 1 1 1 1] | 9 |
| | | punctured | (3 × 996-tone MRU 1) | |
| | | | [1 1 x x 1 1 1 1] | 10 |
| | | | (3 × 996-tone MRU 2) | |
| | | | [1 1 1 1 x x 1 1] | 11 |
| | | | (3 × 996-tone MRU 3) | |
| | | | [1 1 1 1 1 1 x x] | 12 |
| | | | (3 × 996-tone MRU 4) | |
| | | 80 MHz and | [x x x 1 1 1 1 1] | 13 |
| | | 40 MHz in | (2 × 996 + 484-tone MRU 7) | |
| | | 320 MHz are | [x x 1 x 1 1 1 1] | 14 |
| | | punctured | (2 × 996 + 484-tone MRU 8) | |
| | | | [x x 1 1 x 1 1 1] | 15 |
| | | | (2 × 996 + 484-tone MRU 9) | |
| | | | [x x 1 1 1 x 1 1] | 16 |
| | | | (2 × 996 + 484-tone MRU 10) | |
| | | | [x x 1 1 1 1 x 1] | 17 |
| | | | (2 × 996 + 484-tone MRU 11) | |
| | | | [x x 1 1 1 1 1 x] | 18 |
| | | | (2 × 996 + 484-tone MRU 12) | |
| | | | [x 1 1 1 1 1 x x] | 19 |
| | | | (2 × 996 + 484-tone MRU 1) | |
| | | | [1 x 1 1 1 1 x x] | 20 |
| | | | (2 × 996 + 484-tone MRU 2) | |
| | | | [1 1 x 1 1 1 x x] | 21 |
| | | | (2 × 996 + 484-tone MRU 3) | |
| | | | [1 1 1 x 1 1 x x] | 22 |
| | | | (2 × 996 + 484-tone MRU 4) | |
| | | | [1 1 1 1 x 1 x x] | 23 |
| | | | (2 × 996 + 484-tone MRU 5) | |
| | | | [1 1 1 1 1 x x x] | 24 |
| | | | (2 × 996 + 484-tone MRU 6) | |

| | |
|---|---|
| Specific puncturing pattern | 31 |

For other descriptions of the first U-SIG field and the first EHT-SIG field, refer to other implementations. For example, a bandwidth field in the first U-SIG field may indicate the entire bandwidth, or indicate the third bandwidth. This is not limited in embodiments of the present disclosure.

In a second manner, the NDP includes third indication information, where the third indication information indicates the puncturing information in the first bandwidth, and the third indication information is carried in a first EHT-SIG field.

### Implementation 4:

The first EHT-SIG field includes a resource unit (RU) allocation subfield, and the third indication information is implemented by using the resource unit allocation subfield. For example, the resource unit allocation subfield may indicate a resource unit allocation status in a bandwidth of an 80 MHz frequency subblock (when a bandwidth is less than or equal to 80 MHz, only one frequency subblock exists, and when a bandwidth is greater than 80 MHz, a number of frequency subblocks is equal to a value obtained by dividing the bandwidth by 80 MHz) in which an OFDMA-based NDP is located. For example, a bit length of the resource unit allocation subfield is nine bits. For example, when a value of the resource unit allocation subfield is 26 (which is “000011010” in binary), it indicates that a 20 MHz subchannel is punctured. It may be understood that a number of resource unit allocation subfields included in the first EHT-SIG field is not limited in embodiments of the present disclosure. For example, puncturing information in an entire bandwidth may be indicated by using the resource unit allocation subfield included in the first EHT-SIG field. For another example, puncturing information in a bandwidth of one frequency subblock may be indicated by using the resource unit allocation subfield included in the first EHT-SIG field.

### Implementation 5:

The first EHT-SIG field includes a bitmap subfield, and the third indication information is implemented by using the bitmap subfield in the first EHT-SIG field. Optionally, a bit length of the bitmap subfield is 16 bits. For example, each bit in the bitmap subfield may indicate a puncturing status of a corresponding 20 MHz subchannel. Optionally, a bit length of the bitmap subfield may be eight bits, and each bit indicates a puncturing status of a corresponding 40 MHz subchannel. It may be understood that the bitmap subfield may sequentially indicate, in ascending order of frequencies, whether a 20 MHz subchannel is punctured. Alternatively, the bitmap subfield may sequentially indicate, in descending order of frequencies, whether a 20 MHz subchannel is punctured. Implementation 6:

Optionally, the first EHT-SIG field includes four 4-bit subfields, and each 4-bit subfield may indicate puncturing information in one 80 MHz frequency subblock. That is, the third indication information is implemented by using the four 4-bit subfields. For example, there are 16 binary values of each 4-bit subfield, which are respectively 0000, 0001, 0010, 0011, 0100, 0101, 0110, 0111, 1000, 1001, 1010, 1011, 1100, 1101, 1110, and 1111. The following nine binary values may indicate puncturing patterns in the 80 MHz frequency subblock: 1111, 0111, 1011, 1101, 1110, 0011, 1100, 1001, and 0000. The other seven patterns may be reserved, and a reservation sequence is not limited.

Optionally, the first EHT-SIG field includes four 3-bit subfields, and each 3-bit subfield may indicate a puncturing status in one 80 MHz frequency subblock. That is, the third indication information is implemented by using the four 3-bit subfields. For example, there are eight binary values of each 3-bit subfield, and the eight binary values may indicate the following eight puncturing patterns in the 80 MHz frequency subblock: 1111, 0111, 1011, 1101, 1110, 0011, 1100, and 1001.

It may be understood that the implementation 4 to the implementation 6 shown above may be understood as redefining a common field in an EHT-SIG field to support an OFDMA-based NDP.

In a third manner, the NDP includes third indication information, where the third indication information indicates the puncturing information in the first bandwidth, and the third indication information is carried in a first U-SIG field.

### Implementation 7:

A value of a puncturing information indication field included in the first U-SIG field is a second special value, where the second special value indicates an OFDMA-specific puncturing pattern. For example, the third indication information may be implemented by using a 5-bit puncturing information indication field in the first U-SIG field. If the value of the puncturing information indication field is not a value shown in Table 1b, when obtaining the first U-SIG field, the second communication apparatus may learn of, based on the second special value, that the puncturing information indication field is a specific puncturing pattern sent to the second communication apparatus. For example, when the second special value is 31, it may indicate that a puncturing pattern of the first bandwidth (for example, 160 MHz) is [11111001]. For another example, when the second special value is 30, it may indicate that a puncturing pattern of the first bandwidth (for example, 320 MHz) is [1111 1100 1111 1100]. For another example, when the second special value is 31, it may indicate that a puncturing pattern of the first bandwidth (for example, 320 MHz) is [1111 1100 1100 1100]. It may be understood that the second special value may be the same as or different from the first special value. This is not limited in embodiments of the present disclosure.

It may be understood that, for the implementation 4 to the implementation 7, because the first EHT-SIG field includes the puncturing information, or the first U-SIG field includes the puncturing information, when obtaining at least one of any first U-SIG field or any first EHT-SIG field, the second communication apparatus may perform channel sounding.

### Implementation 8:

The third indication information indicates puncturing information in one or more frequency subblocks in the first bandwidth. For example, the first U-SIG field includes puncturing information in 80 MHz in which the first U-SIG field is located. For example, each first U-SIG field may indicate, by using a 4-bit bitmap, puncturing information in 80 MHz in which the first U-SIG field is located. It may be understood that in this implementation, a bandwidth subfield in the first U-SIG field may be the first bandwidth, or may be the third bandwidth. This is not limited in embodiments of the present disclosure. In this implementation, the second communication apparatus needs to obtain an OFDMA puncturing pattern in the first U-SIG field and a non-OFDMA puncturing pattern in the second U-SIG field, to obtain a puncturing pattern of an entire bandwidth.

It should be noted that content, for example, a bandwidth field, a PPDU type and compressed mode, a puncturing information indication field, and an EHT-SIG MCS, of U-SIG fields and/or EHT-SIG fields in different 80 MHz may be different. However, to ensure orthogonality of signals in different 80 MHz, fields need to be aligned. Therefore, the following fields in the U-SIG fields and/or the EHT-SIG fields in different 80 MHz need to be the same: a number of EHT-SIG symbols, a number of EHT-LTF symbols, and a guard interval+a long training field. In addition, it needs to be ensured that a same field in different 80 MHz is a number of spatial flows, so that the R2 station obtains channels with a same number of rows in the entire bandwidth.

It may be understood that the foregoing implementation 1 may be combined with any one of the implementation 2 to the implementation 8, so that both the second communication apparatus and the third communication apparatus can obtain puncturing information in a corresponding bandwidth. Alternatively, the foregoing implementation 2 to implementation 8 may be combined. For example, the implementation 2 or the implementation 3 may be combined with any one of the implementation 4 to the implementation 8. For another example, any one of the implementation 4 to the implementation 6 may be combined with the implementation 8. For another example, any one of the implementation 4 to the implementation 6 is combined with the implementation 7. Examples are not enumerated herein again. When any one of the implementation 4 to the implementation 6 is combined with the implementation 7 or the implementation 8, the R2 station only needs to receive a first U-SIG field and a first EHT-SIG field on one 80 MHz channel in a transmission part that includes only the R2 station. This is simple to implement. However, to ensure alignment between a transmission part that includes the R1 station and the transmission part that includes only the R2 station, because a second EHT-SIG field in the transmission part that includes the R1 station is one symbol, a first EHT-SIG field in the transmission part that includes only the R2 station also needs to be one symbol. Therefore, when the first EHT-SIG field in the transmission part that includes only the R2 station is one symbol, the first EHT-SIG field can carry more information by improving an EHT-SIG MCS.

### Implementation 9:

A beacon frame includes a disallowed transmission subchannel bitmap, where the disallowed transmission subchannel bitmap indicates the puncturing information in the first bandwidth. For example, the beacon frame periodically sent by the AP includes an EHT operation information element, where the EHT operation information element includes a 16-bit disallowed transmission subchannel bitmap, to semi-statically indicate channel puncturing information in a bandwidth of an entire basic service set.

It may be understood that the implementation 9 shown in embodiments of the present disclosure is applicable to both the R1 station and the R2 station.

In a possible implementation, to enable the second communication apparatus to clearly learn of that an NDP in the first bandwidth is an EHT sounding NDP that matches OFDMA transmission, the NDP shown in the foregoing implementation 3 to the implementation 8 may further include first format information, where the first format information indicates that the NDP in the first bandwidth is an OFDMA-based NDP. The first format information may indicate that a type of the NDP in the first bandwidth is the OFDMA-based NDP, so that the second communication apparatus identifies that the EHT PPDU is the OFDMA-based NDP, to further identify additional puncturing indication information that is more flexible and that is in the EHT PPDU, as the implementation 3 to the implementation 8 shown above.

For example, the first format information may be implemented in any one of the following manners.

1. A value of an EHT PPDU type and compressed mode field in a first U-SIG field in the NDP is set to 3, to indicate that a type of an NDP in the third bandwidth is the OFDMA-based NDP.

2. The first format information is carried in a first U-SIG field. For example, B20 to B24 in a first symbol, B25 in the first symbol, B2 in a second symbol, and B8 in the second symbol in the first U-SIG field indicate that a type of an NDP in the third bandwidth is the OFDMA-based NDP.

3. The first format information is carried in a first EHT-SIG field. For example, B14 and B15 in the first EHT-SIG field indicate that a type of an NDP in the third bandwidth is the OFDMA-based NDP. It may be understood that the third indication information in the foregoing implementation 4 to the implementation 6 may be located after B15, so that the R2 station can sequentially read the first format information and the third indication information.

4. A value of an EHT PPDU type and compressed mode in a first U-SIG field in the NDP is set to 0, to indicate that a type of an NDP in the third bandwidth is the OFDMA-based NDP or DL OFDMA data transmission, and B20 to B24 in a first symbol in the first U-SIG field, B25 in the first symbol in the first U-SIG field, B2 in a second symbol in the first U-SIG field, B8 in the second symbol in the first U-SIG field, or B14 and B15 in a first EHT-SIG field further indicate that the type of the NDP in the third bandwidth is the OFDMA-based NDP.

5. A value of an EHT PPDU type and compressed mode in a first U-SIG field in the NDP is set to 1, to indicate that a type of an NDP in the third bandwidth is SU, a non-OFDMA-based NDP, or the OFDMA-based NDP, and B20 to B24 in a first symbol in the first U-SIG field, B25 in the first symbol in the first U-SIG field, B2 in a second symbol in the first U-SIG field, B8 in the second symbol in the first U-SIG field, or B14 and B15 in a first EHT-SIG field further indicate that a type of the PPDU is the OFDMA-based NDP.

6. A value of an EHT PPDU type and compressed mode in a first U-SIG field in the NDP is set to 0, to indicate that a type of an NDP in the third bandwidth is the OFDMA-based NDP or DL OFDMA data transmission, and the R2 station further identifies, by calculating that a number of symbols in a data field is 0, that the type of the NDP in the third bandwidth is the OFDMA-based NDP.

It may be understood that the foregoing implementations of the first format information are merely examples, and should not be understood as a limitation on embodiments of the present disclosure.

In addition, the present disclosure further provides the following embodiments:

In the implementation 9 shown above, the disallowed transmission subchannel bitmap in the EHT operation information element in the beacon frame may indicate puncturing information. The EHT operation information element may further include channel bandwidth information, where the channel bandwidth information indicates a channel bandwidth of the entire basic service set. It is stipulated in a related standard that a puncturing pattern indicated in a disallowed transmission subchannel bitmap needs to be a non-OFDMA-based puncturing pattern, and a channel bandwidth also needs to match a maximum bandwidth that can be supported in a non-OFDMA puncturing pattern. For example, in ascending order of frequencies in 160 MHz, incumbent users exist in third 20 MHz and seventh 20 MHz. Therefore, the AP cannot use the two 20 MHz. Because it is stipulated that a puncturing pattern needs to be non-OFDMA, referring to Table 1b, the AP can select only a puncturing pattern of 1101, and a channel bandwidth is 80 MHz. As a result, another 80 MHz channel is wasted.

Relatively speaking, in a second version of the related standard shown above, if a limitation that “a puncturing pattern indicated in a disallowed transmission subchannel bitmap needs to be a non-OFDMA-based puncturing pattern” is loosened, however, it is required that when the R1 station reads the disallowed transmission subchannel bitmap based on the non-OFDMA puncturing pattern and a corresponding channel bandwidth, the R1 station may still understand and can obtain, through derivation based on the bitmap, non-OFDMA transmission (as shown in Table 1b) supported by the R1 station. The foregoing example is still used. A puncturing pattern selected by the AP is [1101 1101], and the channel bandwidth is 160 MHz. In this case, the R1 station understands and may perform non-OFDMA transmission-based channel sounding in which a bandwidth is 20 MHz, 40 MHz, or 80 MHz and a puncturing pattern is 1101. Therefore, the R2 station can perform more flexible transmission.

However, if the R1 station does not support the foregoing requirement, the AP needs to provide an additional indication, to indicate a more flexible puncturing pattern and a larger channel bandwidth. In addition, only the R2 station reads the additional indication provided by the AP.

In view of this, embodiments of the present disclosure provide the following solution: The R1 station can receive a PPDU with a bandwidth greater than a channel bandwidth read by the R1 station in the EHT operation information element. That is, the R1 station may receive the PPDU, where the bandwidth of the PPDU is greater than a bandwidth indicated by the channel bandwidth in the EHT operation information element. Therefore, the AP may allocate, in a larger bandwidth to the R1 station, a channel bandwidth supported by the AP. This effectively ensures that the R1 station and the R2 station can perform hybrid data transmission.

Optionally, the R1 station can send the PPDU with the bandwidth greater than the channel bandwidth read by the R1 station in the EHT operation information element, and transmit data on some resource units in the channel bandwidth supported by the R1 station in the PPDU.

For example, for the R1 station, a bandwidth is 80 MHz, and a puncturing pattern is [1101]; and for the R2 station, a bandwidth is 160 MHZ, and a puncturing pattern is [1101 1101]. In this case, the AP may send an OFDMA transmission-based PPDU whose bandwidth is 160 MHz, and may perform OFDMA transmission. For example, a puncturing pattern in primary 80 MHz of a total bandwidth of the PPDU is [1101], and a puncturing pattern in secondary 80 MHz of the total bandwidth of the PPDU is [1101]. Data sent to the R1 station is included in the primary 80 MHZ, and data sent to the R2 station may be included in the entire 160 MHz bandwidth. That is, when the R1 station receives the OFDMA transmission-based PPDU whose bandwidth is 160 MHz and is larger than 80 MHz read by the R1 station in the EHT operation information element, the R1 station may normally receive the PPDU.

Generally, the STA may not read a PPDU whose bandwidth is greater than the channel bandwidth of the entire basic service set, because in a basic service set associated with the STA, no device sends a PPDU whose bandwidth is greater than the channel bandwidth of the entire basic service set.

However, because ideas of the R1 station and the R2 station are introduced in the present disclosure, when the AP communicates with the R2 station, a larger bandwidth is supported. Therefore, the R1 station needs to transmit or receive a PPDU whose bandwidth is greater than the channel bandwidth read by the R1 station in the EHT operation information element. This improves a system throughput rate and spectrum utilization.

The following describes a communication apparatus provided in embodiments of the present disclosure.

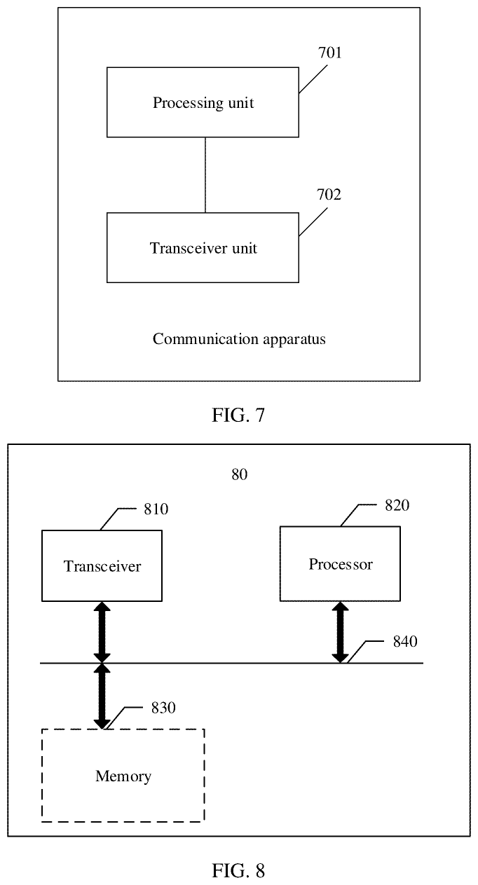

In the present disclosure, the communication apparatus is divided into functional modules based on the foregoing method embodiments. For example, each functional module may be divided to each corresponding function, or two or more functions may be integrated into one processing module. The integrated module may be implemented in a form of hardware, or may be implemented in a form of a software functional module. It should be noted that, in the present disclosure, module division is an example, and is merely a logical function division. In actual implementation, another division manner may be used. The following describes in detail the communication apparatus in embodiments of the present disclosure with reference to FIG. 7 to FIG. 9.

FIG. 7 is a diagram of a structure of a communication apparatus according to an embodiment of the present disclosure. As shown in FIG. 7, the communication apparatus includes a processing unit 701 and a transceiver unit 702.

In some embodiments of the present disclosure, the communication apparatus may be the first communication apparatus shown above. That is, the communication apparatus shown in FIG. 7 may be configured to perform steps, functions, or the like performed by the first communication apparatus in the foregoing method embodiments. For example, the first communication apparatus may be a beamformer device, a chip, or the like. This is not limited in this embodiment of the present disclosure.

The transceiver unit 702 is configured to: send an NDPA frame, and send an NDP.

For example, the processing unit 701 is configured to: obtain an NDPA frame, and send the NDPA frame through the transceiver unit 702. For example, the processing unit 701 is configured to: obtain an NDP, and send the NDP through the transceiver unit 702.

In a possible implementation, the transceiver unit 702 is further configured to receive at least one of a first beamforming report or a second beamforming report.

For example, the processing unit 701 is configured to perform beamforming, resource scheduling, and the like based on at least one of the first beamforming report or the second beamforming report.

In a possible implementation, the transceiver unit 702 is further configured to send a trigger frame.

It may be understood that for specific descriptions of the NDPA frame, the NDP, the trigger frame, the beamforming report, first indication information, second indication information, third indication information, first format information, second format information, and the like, refer to the foregoing method embodiments.

It may be understood that specific descriptions of the transceiver unit and the processing unit shown in this embodiment are merely examples. For specific functions, steps, or the like of the transceiver unit and the processing unit, refer to the foregoing method embodiments (for example, including FIG. 3 and FIG. 6).

FIG. 7 is reused. In some other embodiments of the present disclosure, the communication apparatus may be the second communication apparatus shown above. That is, the communication apparatus shown in FIG. 7 may be configured to perform steps, functions, or the like performed by the second communication apparatus in the foregoing method embodiments. For example, the second communication apparatus may be a beamformee device, a chip, or the like. This is not limited in this embodiment.

The transceiver unit 702 is configured to receive an NDPA frame and an NDP.

For example, the processing unit 701 is configured to perform channel estimation based on the NDPA frame and the NDP, to obtain a first beamforming report.

In a possible implementation, the transceiver unit 702 is further configured to send the first beamforming report.

It may be understood that for specific descriptions of the NDPA frame, the NDP, the trigger frame, the beamforming report, first indication information, second indication information, third indication information, first format information, second format information, and the like, refer to the foregoing method embodiments.

It may be understood that specific descriptions of the transceiver unit and the processing unit shown in this embodiment are merely examples. For specific functions, steps, or the like of the transceiver unit and the processing unit, refer to the foregoing method embodiments (for example, including FIG. 3 and FIG. 6).

The foregoing describes the first communication apparatus and the second communication apparatus in embodiments of the present disclosure. The following describes possible product forms of the first communication apparatus and the second communication apparatus. It should be understood that a product in any form that has functions of the first communication apparatus in FIG. 7 or a product in any form that has functions of the second communication apparatus in FIG. 7 falls within the protection scope of embodiments of the present disclosure. It should be further understood that the following description is merely an example, and product forms of the first communication apparatus and the second communication apparatus in embodiments of the present disclosure are not limited thereto.

In the communication apparatus shown in FIG. 7, the processing unit 701 may be one or more processors, and the transceiver unit 702 may be a transceiver, or the transceiver unit 702 may be a sending unit and a receiving unit. The sending unit may be a transmitter, the receiving unit may be a receiver, and the sending unit and the receiving unit are integrated into one device, for example, a transceiver. In this embodiment, the processor and the transceiver may be coupled, or the like. A connection manner between the processor and the transceiver is not limited in this embodiment.

As shown in FIG. 8, a communication apparatus 80 includes one or more processors 820 and a transceiver 810.

For example, when the communication apparatus is configured to perform steps, methods, or functions performed by the first communication apparatus, the transceiver 810 is configured to send an NDPA frame and an NDP. Optionally, the transceiver 810 is further configured to send a trigger frame. Optionally, the transceiver 810 is further configured to receive at least one of a first beamforming report or a second beamforming report.

For example, when the communication apparatus is configured to perform steps, methods, or functions performed by the second communication apparatus, the transceiver 810 is configured to receive an NDPA frame and an NDP. Optionally, the processor 820 is configured to generate a first beamforming report and the like. Optionally, the transceiver 810 is further configured to receive a trigger frame. Optionally, the transceiver 810 is further configured to send a first beamforming report.

It may be understood that for specific descriptions of the NDPA frame, the NDP, the trigger frame, the beamforming report, first indication information, second indication information, third indication information, first format information, second format information, and the like, refer to the foregoing method embodiments.

It may be understood that for specific descriptions of the processor and the transceiver, refer to descriptions of the processing unit, the sending unit, and the receiving unit shown in FIG. 7.

In various implementations of the communication apparatus shown in FIG. 8, the transceiver may include a receiver and a transmitter. The receiver is configured to perform a receiving function (or operation), and the transmitter is configured to perform a transmitting function (or operation). In addition, the transceiver is configured to communicate with another device/apparatus through a transmission medium.

Optionally, the communication apparatus 80 may further include one or more memories 830 that are configured to store program instructions and/or data. The memory 830 is coupled to the processor 820. A coupling in this embodiment may be an indirect coupling or a communication connection between apparatuses, units, or modules in an electrical form, a mechanical form, or another form, and is for information exchange between the apparatuses, the units, or the modules. The processor 820 may cooperate with the memory 830. The processor 820 may execute program instructions stored in the memory 830. Optionally, at least one of the one or more memories may be included in the processor.

In this embodiment, a specific connection medium between the transceiver 810, the processor 820 and the memory 830 is not limited. In this embodiment, in FIG. 8, the memory 830, the processor 820, and the transceiver 810 are connected to each other through a bus 840. The bus is represented by using a thick line in FIG. 8. A connection manner between other components is only schematically described, but is not used as a limitation. The bus may be classified into an address bus, a data bus, a control bus, and the like. For ease of representation, only one thick line is for representing the bus in FIG. 8, but this does not mean that there is only one bus or only one type of bus.

In this embodiment, the processor may be a general-purpose processor, a digital signal processor, an application-specific integrated circuit, a field programmable gate array or another programmable logic device, a discrete gate or a transistor logic device, a discrete hardware component, or the like, and the processor may implement or execute the methods, the steps, and the logical block diagrams disclosed in embodiments of the present disclosure. The general-purpose processor may be a microprocessor or any conventional processor or the like. The steps of the methods disclosed in combination with embodiments of the present disclosure may be directly implemented by a hardware processor, or may be implemented by using a combination of hardware and software modules in the processor, or the like.

In this embodiment, the memory may include but is not limited to a nonvolatile memory such as a hard disk drive (HDD) or a solid-state drive (SSD), a random access memory (RAM), an erasable programmable read-only memory (erasable programmable ROM, EPROM), a read-only memory (ROM), or a portable read-only memory (compact disc read-only memory, CD-ROM). The memory is any storage medium that can be used to carry or store program code in a form of an instruction or a data structure and that can be read and/or written by a computer (for example, the communication apparatus shown in the present disclosure), but is not limited thereto. The memory in this embodiment may alternatively be a circuit or any other apparatus that can implement a storage function, and is configured to store program instructions and/or data.

The processor 820 is mainly configured to: process a communication protocol and communication data, control the entire communication apparatus, execute a software program, and process data of the software program. The memory 830 is mainly configured to store the software program and the data. The transceiver 810 may include a control circuit and an antenna. The control circuit is mainly configured to: perform conversion between a baseband signal and a radio frequency signal, and process the radio frequency signal. The antenna is mainly configured to receive and send a radio frequency signal in a form of an electromagnetic wave. An input/output apparatus, such as a touchscreen, a display, or a keyboard, is mainly configured to: receive data input by a user and output data to the user.

After the communication apparatus is powered on, the processor 820 may read the software program in the memory 830, interpret and execute instructions of the software program, and process the data of the software program. When data needs to be sent in a wireless manner, the processor 820 outputs a baseband signal to a radio frequency circuit after performing baseband processing on the to-be-sent data, and the radio frequency circuit performs radio frequency processing on the baseband signal, and then sends the radio frequency signal outwards through the antenna in a form of an electromagnetic wave. When data is sent to the communication apparatus, the radio frequency circuit receives a radio frequency signal through the antenna, converts the radio frequency signal into a baseband signal, and outputs the baseband signal to the processor 820, and the processor 820 converts the baseband signal into data and processes the data.

In another implementation, the radio frequency circuit and the antenna may be disposed independent of the processor that performs baseband processing. For example, in a distributed scenario, the radio frequency circuit and the antenna may be remotely disposed independent of the communication apparatus.

It may be understood that the communication apparatus shown in this embodiment may alternatively include more components than those shown in FIG. 8, or the like. This is not limited in this embodiment. The foregoing methods performed by the processor and the transceiver are merely examples. For specific steps performed by the processor and the transceiver, refer to the methods described above.

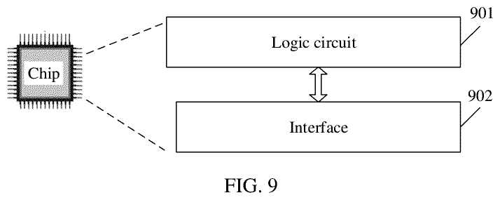

In another possible implementation, in the communication apparatus shown in FIG. 7, the processing unit 701 may be one or more logic circuits, and the transceiver unit 702 may be an input/output interface, or may be referred to as a communication interface, an interface circuit, an interface, or the like. Alternatively, the transceiver unit 702 may include a sending unit and a receiving unit, the sending unit may be an output interface, the receiving unit may be an input interface, and the sending unit and the receiving unit are integrated into one unit, for example, an input/output interface. As shown in FIG. 9, a communication apparatus shown in FIG. 9 includes a logic circuit 901 and an interface 902. That is, the processing unit 701 may be implemented by using the logic circuit 901, and the transceiver unit 702 may be implemented by using the interface 902. The logic circuit 901 may be a chip, a processing circuit, an integrated circuit, a system on chip (SoC), or the like. The interface 902 may be a communication interface, an input/output interface, a pin, or the like. For example, in FIG. 9, the foregoing communication apparatus is shown by using a chip as an example, and the chip includes the logic circuit 901 and the interface 902.

In this embodiment, the logic circuit and the interface may be further coupled to each other. A specific connection manner between the logic circuit and the interface is not limited in this embodiment.

For example, when the communication apparatus is configured to perform methods, functions, or steps performed by the first communication apparatus, the logic circuit 901 is configured to obtain an NDPA frame, the interface 902 is configured to output the NDPA frame, the logic circuit 901 is configured to obtain an NDP, and the interface 902 is configured to output the NDP. Optionally, the interface 902 is further configured to output a trigger frame. Optionally, the interface 902 is further configured to input at least one of a first beamforming report or a second beamforming report. Optionally, the logic circuit 901 is further configured to perform beamforming, resource scheduling, and the like based on at least one of the first beamforming report or the second beamforming report.

For example, when the communication apparatus is configured to perform methods, functions, or steps performed by the second communication apparatus, the interface 902 is configured to input an NDPA frame and an NDP. For example, the logic circuit 901 is configured to perform channel estimation based on the NDPA frame and the NDP, to obtain a first beamforming report. Optionally, the interface 902 is further configured to input a trigger frame. Optionally, the interface 902 is further configured to output the first beamforming report.

It may be understood that the communication apparatus shown in this embodiment may implement the method provided in embodiments of the present disclosure in a form of hardware, or may implement the method provided in embodiments of the present disclosure in a form of software. This is not limited in this embodiment.

It may be understood that for specific descriptions of the NDPA frame, the NDP, the trigger frame, the beamforming report, first indication information, second indication information, third indication information, first format information, second format information, and the like, refer to the foregoing method embodiments.

For specific implementations of embodiments shown in FIG. 9, refer to the foregoing embodiments. Details are not described herein.

An embodiment of this application further provides a wireless communication system. The wireless communication system includes a first communication apparatus and a second communication apparatus. The first communication apparatus and the second communication apparatus may be configured to perform the method in any one of the foregoing embodiments (as shown in FIG. 3 and FIG. 6).

In addition, the present disclosure further provides a computer program. The computer program is used to implement operations and/or processing performed by the first communication apparatus in the method provided in the present disclosure.

The present disclosure further provides a computer program. The computer program is used to implement operations and/or processing performed by the second communication apparatus in the method provided in the present disclosure.

The present disclosure further provides a computer-readable storage medium. The computer-readable storage medium stores computer code, and when the computer code is run on a computer, the computer is enabled to perform operations and/or processing performed by the first communication apparatus in the method provided in the present disclosure.

The present disclosure further provides a computer-readable storage medium. The computer-readable storage medium stores computer code, and when the computer code is run on a computer, the computer is enabled to perform operations and/or processing performed by the second communication apparatus in the method provided in this application.

The present disclosure further provides a computer program product. The computer program product includes computer code or a computer program, and when the computer code or the computer program is run on a computer, operations and/or processing performed by the first communication apparatus in the method provided in the present disclosure are/is performed.

The present disclosure further provides a computer program product. The computer program product includes computer code or a computer program, and when the computer code or the computer program is run on a computer, operations and/or processing performed by the second communication apparatus in the method provided in the present disclosure are/is performed.

In the several embodiments provided in the present disclosure, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network units. Some or all of the units may be selected based on an actual requirement to implement the technical effects of the solutions provided in embodiments of the present disclosure.

In addition, functional units in embodiments of the present disclosure may be integrated into one processing unit, each of the units may exist alone physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of the present disclosure essentially, or the part contributing to the conventional technologies, or all or some of the technical solutions may be implemented in a form of a software product. The software product is stored in a storage medium and includes a plurality of instructions for instructing a computer device (which may be a personal computer, a server, or a network device) to perform all or some of the steps of the methods described in embodiments of the present disclosure. The readable storage medium includes any medium that can store program code, such as a USB flash drive, a removable hard disk, a read-only memory (ROM), a random access memory (RAM), a magnetic disk, or an optical disc.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A channel sounding method, comprising:
sending, by a first communication apparatus, a null data packet announcement (NDPA) frame, wherein the NDPA frame comprises first indication information indicating that the NDPA frame is for orthogonal frequency division multiple access (OFDMA) and non-OFDMA hybrid channel sounding; and
sending, by the first communication apparatus, one or more null data packets (NDPs), wherein a total bandwidth of the one or more NDPs is a first bandwidth, a corresponding portion of the one or more NDPs in the first bandwidth is used by a second communication apparatus to obtain channel state information between the second communication apparatus and the first communication apparatus, a corresponding portion of the one or more NDPs in a second bandwidth is used by a third communication apparatus to obtain channel state information between the third communication apparatus and the first communication apparatus, the second bandwidth is a part of the first bandwidth, and the first bandwidth is greater than 80 MHz.

2. The method according to claim 1, further comprising:
receiving, by the first communication apparatus, a first beamforming report from the second communication apparatus, wherein the first beamforming report indicates the channel state information in the first bandwidth; and
receiving, by the first communication apparatus, a second beamforming report from the third communication apparatus, wherein the second beamforming report indicates the channel state information in the second bandwidth.

3. A first communication apparatus, comprising at least one processor, a memory and a transceiver, and the memory stores instructions that, when executed by the at least one processor, cause the first communication apparatus to:
send a null data packet announcement (NDPA) frame via the transceiver, wherein the NDPA frame comprises first indication information, and the first indication information indicates that the NDPA frame is for orthogonal frequency division multiplexing multiple access (OFDMA) and non-OFDMA hybrid channel sounding; and
send one or more null data packets (NDPs) via the transceiver, wherein a total bandwidth of the one or more NDPs is a first bandwidth, a corresponding portion of the one or more NDPs in the first bandwidth is used by a second communication apparatus to obtain channel state information between the second communication apparatus and the first communication apparatus, a corresponding portion of the one or more NDPs in a second bandwidth is used by a third communication apparatus to obtain channel state information between the third communication apparatus and the first communication apparatus, the second bandwidth is a part of the first bandwidth, and the first bandwidth is greater than 80 MHz.

4. The first communication apparatus according to claim 3, wherein the instructions, when executed by the at least one processor, further cause the first communication apparatus to:
receive a first beamforming report from the second communication apparatus via the transceiver, wherein the first beamforming report indicates the channel state information in the first bandwidth; and
receive a second beamforming report from the third communication apparatus via the transceiver, wherein the second beamforming report indicates the channel state information in the second bandwidth.

5. A second communication apparatus, comprising at least one processor, a memory and a transceiver, and the memory stores instructions that, when executed by the at least one processor, cause the second communication apparatus to:
receive a null data packet announcement (NDPA) frame via the transceiver, wherein the NDPA frame comprises first indication information, and the first indication information indicates that the NDPA frame is for orthogonal frequency division multiplexing multiple access (OFDMA) and non-OFDMA hybrid channel sounding; and
receive one or more null data packets (NDPs) via the transceiver, wherein a total bandwidth of the one or more NDPs is a first bandwidth, a corresponding portion of the one or more NDPs in the first bandwidth is used by the second communication apparatus to obtain channel state information between the second communication apparatus and a first communication apparatus.

6. The second communication apparatus according to claim 5, wherein the instructions, when executed by the at least one processor, further cause the second communication apparatus to:
send a first beamforming report to the first communication apparatus, wherein the first beamforming report indicates the channel state information in the first bandwidth.

7. The first communication apparatus according to claim 3, wherein the NDPA frame further comprises second indication information indicating puncturing information in the first bandwidth.

8. The first communication apparatus according to claim 7, wherein the second indication information further indicates the second communication apparatus to feed back channel state information of a nonpunctured subchannel in the first bandwidth.

9. The first communication apparatus according to claim 3, wherein the one or more NDPs comprise third indication information indicating puncturing information in the first bandwidth.

10. The first communication apparatus according to claim 9, wherein the third indication information is carried in a first universal signal (U-SIG) field, and that the third indication information indicates puncturing information in the first bandwidth comprises: the third indication information indicates puncturing information in one or more frequency subblocks in the first bandwidth.

11. The first communication apparatus according to claim 9, wherein the third indication information is carried in a first extremely high throughput signal (EHT-SIG) field.

12. The first communication apparatus according to claim 9, wherein the one or more NDPs further comprise first format information indicating that each of the one or more NDPs in the first bandwidth is an OFDMA-based NDP.

13. The first communication apparatus according to claim 3, wherein the one or more NDPs comprise a second universal signal (U-SIG) field, the second U-SIG field comprises fourth indication information and second format information, the fourth indication information indicates puncturing information in the second bandwidth, and the second format information indicates that the corresponding portion of the one or more NDPs in the second bandwidth is a non-OFDMA-based NDP.

14. The first communication apparatus according to claim 3, wherein the NDPA frame further comprises bandwidth information indicating at least one of the first bandwidth or the second bandwidth.

15. The method according to claim 1, wherein the NDPA frame further comprises second indication information indicating puncturing information in the first bandwidth.

16. The method according to claim 15, wherein the second indication information further indicates the second communication apparatus to feed back channel state information of a nonpunctured subchannel in the first bandwidth.

17. The method according to claim 1, wherein the one or more NDPs comprise third indication information indicating puncturing information in the first bandwidth.

18. The method according to claim 17, wherein the third indication information is carried in a first universal signal (U-SIG) field, and that the third indication information indicates puncturing information in the first bandwidth comprises: the third indication information indicates puncturing information in one or more frequency subblocks in the first bandwidth.

19. The method according to claim 1, wherein the one or more NDPs comprise a second universal signal (U-SIG) field, the second U-SIG field comprises fourth indication information and second format information, the fourth indication information indicates puncturing information in the second bandwidth, and the second format information indicates that the corresponding portion of the one or more NDPs in the second bandwidth is a non-OFDMA-based NDP.

20. The method according to claim 1, wherein the NDPA frame further comprises bandwidth information indicating at least one of the first bandwidth or the second bandwidth.
